(19) United States
(12) Patent Application Publication
(10) Pub. No.: US 2006/0087794 A1
(43) Pub. Date: Apr. 27, 2006

(54) Capacitor layer forming material, method of manufacturing a composite foil used where manufacturing the same, and print wiring board having a circuit where a capacitor is embedded, obtained by using the same

(75) Inventors: Tomohiro Sakata, Ageo-shi (JP); Kazuko Taniguchi, Ageo-shi (JP); Makoto Dobashi, Ageo-shi (JP)

Correspondence Address: ROTHWELL, FIGG, ERNST & MANBECK, P.C., 1425 K STREET, N.W., SUITE 800, WASHINGTON, DC, 20005, US

(73) Assignee: Mitsui Mining & Smelting Co., Ltd., Tokyo (JP)

(21) Appl. No.: 11/259,354

(22) Filed: Oct. 27, 2005

Related U.S. Application Data
(60) Provisional application No. 60/623,248, filed on Nov. 1, 2004.

(30) Foreign Application Priority Data
Oct. 27, 2004 (JP) JP2004-313137

(51) Int. Cl. H01G 4/005

(52) U.S. Cl. 361/303

(57) ABSTRACT

It is an object to provide a capacitor layer forming material useful for a printed wiring board with a substrate of fluorine resin, liquid-crystal polymer or the like, which is fabricated by hot-pressing at 300 to 400° C., and showing no deterioration in strength after the hot-pressing. In order to achieve the object, the capacitor layer forming material, comprising a first electroconductive layer used for forming an upper electrode and second electroconductive layer used for forming a lower electrode with a dielectric layer in-between for a printed wiring board, has the second electroconductive layer made of a composite foil comprising a copper layer coated with one or more layers of, plated hard nickel, plated cobalt and plated nickel/cobalt alloy.

### BACKGROUND OF THE INVENTION

1. Field of the Invention

The present invention relates to a material for forming a capacitor layer to be built in a printed wiring board, method for producing a composite foil used for forming the capacitor layer forming material, and printed wiring board provided with a built-in capacitor circuit in which the same material is used.

2. Description of the Related Art

A multilayer printed wiring board provided with a built-in capacitor circuit (element) uses one or more insulation layers positioned in the inner layer for the board as dielectric layer(s). An inner circuit positioned on each side of a dielectric layer includes a capacitor circuit with an upper and lower electrodes facing each other, as disclosed by Patent Document 1 (JP-A 2003-105205). This capacitor works as a built-in capacitor. The capacitor circuit is generally formed with a capacitor layer forming material having a layered structure of first electroconductive layer/dielectric layer/second electroconductive layer. A built-in capacitor circuit has been produced by various methods. For example, an electroconductive layer of the capacitor layer forming material is etched before being assembled in a capacitor circuit, and laminated on a built-in board. An electroconductive layer can also be etched after the capacitor circuit in which it is used is laminated on a built-in board.

A dielectric layer, in which a metallic foil is used, has also been produced by various methods. Patent Document 2 (JP-A 9-040933) discloses a method in which a resin composition dispersed with dielectric filler is spread on a metallic foil. Patent Document 3 (JP-A 2004-250687) discloses a method in which films each dispersed with dielectric filler are laminated on each other. Patent Document 4 (U.S. Pat. No. 6,541,137) discloses a method which uses a sol-gel process to which chemical vapor disposition is applied.

As disclosed by these documents, a material for the electroconductive layer to sandwich the dielectric layers is mainly composed of copper, e.g., copper foil. Patent Document 4 (U.S. Pat. No. 6,541,137) discloses an upper electrode coated with a nickel/phosphorus alloy layer on the surface of a lower electrode to improve adhesion of the electrode to the dielectric layer and, at the same time, to improve electrical properties of the layers, including the dielectric constant.

A capacitor, which can save power for electronic/electric devices by storing surplus power, is required to have as high a capacitance as possible as a basic property. Capacitance (C) is given by the formula C=εεₒ(A/d), where εₒ is dielectric constant under vacuum. It is however apparent that a capacitor has a limit in improvement for surface area (A), because increasing capacitor electrode area beyond a certain level is impossible in a printed wiring board area of given size. Therefore, several attempts have been made to increase both the capacitance of a capacitor of constant capacitor electrode surface area (A) and its specific dielectric constant (ε) of its dielectric layer by, for example, decreasing thickness (d) of the dielectric layer or devising layered structure for the capacitor circuit as a whole.

As IC chips have become integrated to a higher degree, printed wiring boards emit more heat. Improved high frequency characteristics of the device, however, must be retained. Therefore, printed wiring boards with a substrate of fluorine resin, liquid-crystal polymer or the like have been sought and produced to satisfy these requirements, as disclosed by Patent Documents 5 (JP-A2003-171480) and 6 (JP-A2003-124580).

Decreasing thickness of the dielectric layer, however, will lead to decreased thickness of the capacitor layer forming material itself. Because the decreased thickness increases the fragility of the material, undesirable increases in breakage occur.

Similarly, when a sol-gel process is employed to produce the dielectric layer on a metallic foil, the resulting product becomes brittle through oxidation as a result of heating the sol-gel film to 600° C., as disclosed by Patent Document 4. In another example, a capacitor having a lower electrode coated with a nickel/phosphorus alloy layer may involve disadvantages resulting from possible delamination of the electrode and alloy layer from each other due to insufficient adhesion between them. A delaminated capacitor may fail to satisfy design properties due to its variable capacitance. The delaminated portion may serve as an origin of further delamination of another portion in the printed wiring board, causing other problems such as interlayer delamination in the presence of thermal shock resulting from soldering reflow or the like. Collectively, these problems damage product life and limit usefulness of the product.

Attempts have been made to use a multilayer substrate of fluorine resin, liquid-crystal polymer or the like in place of a conventional glass/epoxy substrate because of favorable heat resistance and high-frequency characteristics. These substrates share several demanding requirements for production including the need for very high pressing temperatures of 300 to 400° C. and must be composed of a hard material. Therefore, a capacitor material that has the properties of resistance to material change when subjected to pressing at high temperature of 300 to 400° C. and when, pressed by the hard substrate material, is able to withstand expansion and contraction of the surrounding materials, would be advantageous.

Therefore, the markets have sought capacitor layer forming materials with several key properties, including good adhesion to a dielectric layer when used as a lower electrode in a capacitor circuit; good retention of structural integrity during manufacture under extremes of temperature and physical force; effectiveness in forming an electroconductive layer in a lower electrode such as resistor electrodes or the like and usefulness in reducing circuit size.

### SUMMARY OF THE INVENTION

After extensive studies, the inventors of the present invention have found that use of the capacitor layer forming material described below can secure high adhesion between its dielectric layer and lower electrode, and keep sufficient strength, even when its dielectric layer has a reduced thickness, to have improved handling-related safety.

Moreover, the material shows no deterioration of strength even when used in a printed wiring board with a substrate of fluorine resin, liquid-crystal polymer or the like and fabricated by pressing at high temperature of 300 to 400° C. At the same time, use of the capacitor layer forming material described below for a capacitor circuit can improve circuit capacitance.

<Capacitor Layer Forming Material of the Present Invention>

FIG. 1 shows a cross-sectional view schematically illustrating a capacitor layer forming material of the present invention. As illustrated, the capacitor layer forming material 1 comprises the first electroconductive layer 2 used for forming an upper electrode and second electroconductive layer 4 used for forming a lower electrode with the dielectric layer 3 in-between. The capacitor layer forming material of the present invention is characterized by using a varying composite foil for the second electroconductive layer 4 used for forming a lower electrode. The composite foils are broadly classified into 3 types; first, second and third composite foils comprising a copper layer coated with 1, 2 and 3 dissimilar metal layers, respectively. Therefore, the capacitor layer forming materials are separately described for the first, second and third capacitor layer forming materials, in accordance with composite foil types for the second electroconductive layer 4.

[First Capacitor Layer Forming Material]

The first capacitor layer forming material 1a is produced using the first composite foil. Its basic layered structure is illustrated in FIG. 1. It includes the second electroconductive layer 4 of varying composite foil, which falls into one of the three basic variations, described below.

Variation 1-i: In the capacitor layer forming material comprising the first electroconductive layer used for forming an upper electrode and second electroconductive layer used for forming a lower electrode with the dielectric layer in-between for a printed wiring board, the second electroconductive layer is made of a composite foil comprising a copper layer coated with a plated hard nickel layer as the dissimilar metal layer.

Variation 1-ii: In the capacitor layer forming material comprising the first electroconductive layer used for forming an upper electrode and second electroconductive layer used for forming a lower electrode with the dielectric layer in-between for a printed wiring board, the second electroconductive layer is made of a composite foil comprising a copper layer coated with a plated cobalt layer as the dissimilar metal layer.

Variation 1-iii: In the capacitor layer forming material comprising the first electroconductive layer used for forming an upper electrode and second electroconductive layer used for forming a lower electrode with the dielectric layer in-between for a printed wiring board, the second electroconductive layer is made of a composite foil comprising a copper layer coated with a plated nickel/cobalt alloy layer as the dissimilar metal layer.

As described above, the first composite foil 5a comprises the copper layer C coated with the single dissimilar metal layer 6, as illustrated in FIG. 2. It should be noted, as illustrated in FIGS. 2(a) and 2(b), that the copper layer may be coated with the dissimilar metal layer 6 on one or both sides. The first composite foil 5a side on which the dissimilar metal layer is formed serves as the contact surface with the dielectric layer 3. Presence of the dissimilar metal layer helps improve adhesion of the first composite foil to the dielectric layer.

The first composite foil 5a comprises a copper layer coated with any of a plated hard nickel layer, a plated cobalt layer and a nickel/cobalt alloy layer (hereinafter sometimes referred to simply as a “dissimilar metal layer” for ease of description) as the dissimilar metal layer 6. FIG. 2(b) shows the copper layer coated with any of a plated hard nickel layer, a plated cobalt layer and a nickel/cobalt alloy layer (hereinafter referred to as a “plated hard nickel layer or the like) on both sides. The layer is highly resistant to heat, difficult to soften under conditions of 400° C. for 10 hours or so, and can effectively prevent deterioration of tensile strength (strength) of the composite foil as a whole to easily keep a foil tensile strength of 48 kgf/mm² or more after heat treatment. The composite foil, so long as it has the above physical properties, will deteriorate little in strength, even when incorporated in a printed wiring board with a substrate of fluorine resin, liquid-crystal polymer or the like and undergoes pressing at high temperature of 300 to 400° C. Consequently, the capacitor layer forming material in which this first composite foil 5a is used will little deteriorate in quality. The copper layer is coated with a plated hard nickel layer or the like on both sides, because a copper foil, when used as the copper layer, may warp and wind (curling phenomenon) when coated with a plated layer only on one side, resulting in decreased handleability. Another advantage coming from coating the copper layer with a highly oxidation-resistant layer, e.g., plated hard nickel layer or the like, on both sides is to prevent oxidation-induced corrosion of the copper layer itself. The plated hard nickel layer described in this specification is composed of crystal grains highly divided to an average size of 0.3 μm or less having a high mechanical strength.

A copper foil, when used for forming the copper layer, can be electrolytic or rolled one. It preferably has a nominal thickness of 1 to 35 μm. There is a trend for a printed wiring board to become thinner, accompanying the demands for compacter, lighter, thinner electronic devices or the like in which it is used. Therefore, the copper foil for the present invention is designed to have a thickness of 1 to 35 μm, in consideration that it is coated with a plated hard nickel layer or the like. Coating a copper foil having a nominal thickness below 7 μm directly and continuously with a plated hard nickel layer or the like will be difficult and cause drastically deteriorated product yield. In such a case, it is preferable to use a copper foil coated beforehand with a carrier foil, which is coated with a plated hard nickel layer or the like on one side, then treated by an adequate method, e.g., direct lamination on a substrate, and then coated with a plated hard nickel layer or the like on the other side, after the carrier foil is removed. On the other hand, a copper foil having a nominal thickness above 35 μm is not desirable because a capacitor layer forming material thickness will increase beyond the adequate level now required, when the copper foil is coated with a plated hard nickel layer or the like to form the composite foil for the forming material.

Next, a plated hard nickel layer or the like preferably has a thickness of 0.5 to 3.0 μm. A plated hard nickel layer or the like having a thickness below 0.5 μm may not have sufficient strength to improve handleability of the capacitor layer forming material in which it is used together with a thin dielectric layer. And, in addition such a thin layer, may not have sufficient properties when it is to be used for a resistance circuit or the like. Increasing its thickness beyond 3.0 μm may not notably improve the handleability of the capacitor layer forming material in which it is used.

When an electrolytic copper foil is used as the copper layer, a plated hard nickel layer or the like preferably has a variable thickness depending on the surface conditions, e.g., rough or glossy, of the copper layer on which it is formed, to prevent the curling phenomenon described above. For example, an electrolytic copper foil having a nominal thickness of 12 μm coated with a 2.5 μm thick plated hard nickel layer or the like on the glossy surface will be coated with a 3.5 μm thick plated hard nickel layer or the like on the rough surface. Assuming that a plated hard nickel layer or the like formed on the glossy surface has a thickness of “t” μm, then that formed on the rough surface preferably has a thickness of t+0.5 to t+1.2 μm. At a thickness below t+0.5 μM, the layer on the rough surface may not be expected to bring a sufficient effect of preventing the curling phenomenon. At a thickness above t+1.2 μm, on the other hand, the curling phenomenon in the direction opposite to that of the electrolytic copper foil curling may more notably occur.

The first composite foil described above has sufficient softening resistance and a tensile strength of 50 kgf/mm² or more, even when heat-treated under conditions of 400° C. for 10 hours or so. Therefore, it should show no deterioration in mechanical properties when treated at around 180° C. by hot pressing, a temperature level adopted in production of copper-lined laminates. When a pressing temperature above 400° C. is needed, however, a plated cobalt layer or a plated nickel/cobalt alloy layer is more preferable than a plated hard nickel layer. This is because mutual diffusion tends to occur between a layer of hard nickel as a single component and copper foil layer at above 400° C., with the result that the hard nickel layer itself may lose resistance to softener; causing the capacitor layer forming material in which it is used to have deteriorated toughness and handleability.

The first composite foil described above is used for production of the capacitor layer forming material. The methods for producing the first composite foil described above and capacitor layer forming material will be described in detail later in the preferred embodiments.

[Second Capacitor Layer Forming Material]

The second capacitor layer forming material is produced using the second composite foil. Its basic layered structure is illustrated in FIG. 3. It includes the second electroconductive layer 4 of varying composite foil, which falls into one of the two basic variations, described below.

Variation 2-i: In the capacitor layer forming material comprising the first electroconductive layer used for forming an upper electrode and second electroconductive layer used for forming a lower electrode with the dielectric layer in-between for a printed wiring board, the second electroconductive layer is made of a composite foil comprising a copper layer coated with 2 dissimilar metal layers of plated cobalt and plated hard nickel in this order.

Variation 2-ii: In the capacitor layer forming material comprising the first electroconductive layer used for forming an upper electrode and second electroconductive layer used for forming a lower electrode with the dielectric layer in-between for a printed wiring board, the second electroconductive layer is made of a composite foil comprising a copper layer coated with 2 dissimilar metal layers of plated iron and plated hard nickel in this order.

As described above, the second composite foil 5b comprises a copper layer coated with 2 dissimilar metal layers 6a and 6b, as illustrated in FIG. 3. It should be noted, as illustrated in FIG. 2, that the copper layer may be coated with the dissimilar metal layers 6a and 6b on one or both sides. The second composite foil 5b side on which the dissimilar metal layers are formed serves as the contact surface with the dielectric layer 3. Presence of the dissimilar metal layers helps improve adhesion of the second composite foil to the dielectric layer.

The second composite foil 5b comprises a copper layer coated with a plated cobalt or plated iron layer as the dissimilar metal layer 6a and plated hard nickel layer as the other dissimilar metal layer 6b. The copper foil may be coated with the dissimilar metal layers 6a and 6b on both sides, as is the case with the first composite foil 5a, as illustrated in FIG. 2(b).

The second composite foil 5b comprises the copper layer C coated with the dissimilar metal layers 6a (plated cobalt or plated iron layer) and 6b (plated hard nickel layer), in this order. As illustrated in FIG. 2, the copper layer comes into contact with the dissimilar metal layer 6a (plated cobalt or iron layer) on which the dissimilar metal layer 6b (plated hard nickel layer) is formed. When the copper layer is coated with a plated hard nickel layer and plated cobalt layer, in this order, the Kirkendahl effect, in which the plated hard nickel layer and copper foil layer diffuse into each other to migrate the interface thereof, will occur when the laminate is heated at 300° C. or higher, more notably above 400° C., for extended periods to form a copper/nickel alloy region in an extended area in the copper layer. Consequently, the plated hard nickel layer fails to exhibit its inherent high tensile strength. Therefore, the laminated structure illustrated in FIG. 2 is adopted. It is known that the Kirkendahl effect is accompanied by evolution of voids in the diffusion interface. The foil will be easily broken during the tensile test at the area in which fine defects, e.g., voids, are present, because tensile stress concentrates the area.

A photograph is shown in which the composite foils were observed for a generation of the Kirkendahl effect by an optical microscope. First, a cross-section of the copper foil coated with a plated cobalt and plated hard nickel layers in this order on both sides was observed before and after heat treatment. FIG. 5 presents a microgram showing a cross-section of the composite foil before heat treatment by an optical microscope, and FIG. 6 presents a microgram showing the cross-section after heat treatment carried out at 400° C. for 10 hours by an optical microgram. No significant difference was observed between them, indicating that the cross-sectional conditions change little by the heat treatment. By contrast, a significant difference is observed in the cross-section before and after heat treatment with the composite copper foil coated only with a plated hard nickel layer on both sides (first composite copper foil). FIG. 7 presents a microgram showing a cross-section of the first composite copper foil before heat treatment by an optical microscope, and FIG. 8 presents a microgram showing the cross-section after heat treatment carried out at 400° C. for 10 hours by an optical microscope. Comparing FIGS. 7 and 8 in the microgram of the cross-section after heat treatment, void shapes are observed in the copper foil, as arrowed in FIG. 8. These voids are considered to result from the Kirkendahl effect, in which the interface between the plated hard nickel layer and copper foil layer migrates by mutual diffusion due to heating. These results show that a high-quality capacitor can be built in a multilayer printed wiring board treated by pressing at around 400° C., where the capacitor layer forming material is produced using the second composite foil.

It is preferable that the second composite foil comprises the dissimilar metal layers 6a (plated cobalt or iron layer) plated hard nickel layer having a respective thickness of 0.1 to 0.5 and 0.3 to 2.5 μm. The above layered structure is used to secure softening resistance characteristics similar to those of the single plated cobalt layer while minimizing use of expensive cobalt. Where dissimilar metal layer 6a was thickness below 0.1 μm, this may be too thin to work as a barrier layer between the plated hard nickel and copper layers, sufficient to prevent the Kirkendahl effect from occuring. The composite foil will be little different from the one having no dissimilar metal layer 6a, particularly when it is heat treated at above 400° C. Increasing thickness of the dissimilar metal layer 6a beyond 0.5 μm, on the other hand, will eliminate its value, because the effect of a combination of the dissimilar metal layer 6a and plated hard nickel layer will be not different at all from that of the plated hard nickel layer alone. The plated hard nickel layer having a thickness below 0.3 μm will have little contribution to the effect of improving softening resistance characteristics by reinforcing the dissimilar metal layer 6a. Increasing thickness of the plated hard nickel layer beyond 2.5 μm, on the other hand, will diminish its economic efficiency to eliminate value of the two-layered structure.

The second composite foil described above also has sufficient softening resistance and a tensile strength of 50 kgf/mm² or more even when heat-treated under conditions of 400° C. for 10 hours or so. Therefore, it should show little deterioration in strength when treated by hot process carried out at 300 to 400° C. for production of printed wiring boards with a substrate of fluorine resin, liquid-crystal polymer or the like, so long it has the above properties. Accordingly, the capacitor layer forming material produced using the second composite foil 5b will show little deterioration in quality.

The first composite foil described above is used for production of the capacitor layer forming material. The methods for producing the second composite foil described above and capacitor layer forming material will be described in detail later in the preferred embodiments.

[Third Capacitor Layer Forming Material]

The third capacitor layer forming material is produced using the third composite foil. Its basic layered structure is illustrated in FIG. 9. It includes the second electroconductive layer 4 of varying composite foil, which falls into one of the two basic variations, described below.

Variation 3-i: In the capacitor layer forming material comprising the first electroconductive layer used for forming an upper electrode and second electroconductive layer used for forming a lower electrode with the dielectric layer in-between for a printed wiring board, the second electroconductive layer is made of a composite foil comprising a copper layer coated with 3 dissimilar metal layers of plated cobalt (first cobalt layer), plated hard nickel and plated cobalt (second cobalt layer) in this order.

Variation 3-ii: In the capacitor layer forming material comprising the first electroconductive layer used for forming an upper electrode and second electroconductive layer used for forming a lower electrode with the dielectric layer in-between for a printed wiring board, the second electroconductive layer is made of a composite foil comprising a copper layer coated with 3 dissimilar metal layers of plated iron, plated hard nickel and plated cobalt in this order.

As described above, the third composite foil 5c comprises a copper layer coated with 3 dissimilar metal layers 6a, 6b and 6c, as illustrated in FIG. 10. It should be noted, as illustrated in FIG. 10, that the copper layer may be coated with the dissimilar metal layers 6a, 6b and 6c on one or both sides. The third composite foil 5c side on which the dissimilar metal layers are formed serves as the contact surface with the dielectric layer 3. Presence of the dissimilar metal layers can improve adhesion of the third composite foil to the dielectric layer.

The third composite foil 5c comprises a copper layer coated with a first plated cobalt layer as the dissimilar metal layer 6a, a plated hard nickel layer as the dissimilar metal layer 6b and a second plated cobalt layer as the dissimilar metal layer 6c, in this order. Alternatively, the third composite foil 5c comprises a copper layer coated with a plated iron layer as the dissimilar metal layer 6a, a plated hard nickel layer as the dissimilar metal layer 6b and a plated cobalt layer as the dissimilar metal layer 6c, in this order. The copper layer may be coated with the dissimilar metal layers 6a, 6b and 6c on both sides, as is the case with the first composite foil 5a, as illustrated in FIG. 10(b).

The third composite foil 5c according to the invention comprises the copper layer C coated with the dissimilar metal layers 6a (first plated cobalt layer or plated iron layer), 6b (plated hard nickel layer) and 6c (second plated cobalt layer), in this order. As illustrated in FIG. 10, the copper layer comes into contact with the dissimilar metal layer 6a on which the dissimilar metal layers 6b are formed, on which the dissimilar metal layer 6c is formed. The above layered structure is to prevent the Kirkendahl effect and hence retain strength of the foil after it undergoes a load at high temperature. Presence of the outermost cobalt layer improves heat resistance characteristics of the foil.

It is preferable that the third composite foil comprises the dissimilar metal layers 6a (first plated cobalt layer or plated iron layer), 6b (plated hard nickel layer) and 6c (second plated cobalt layer) having a respective thickness of 0.1 to 0.5, 0.3 to 2.5 and 0.1 to 0.5 μm. The above layered structure is adopted for essentially the same reasons for the second composite foil. The dissimilar metal layer 6a having a thickness below 0.1 μm may be too thin to work as a barrier layer between the plated hard nickel and copper foil layers, difficult to prevent the Kirkendahl effect from generating. The composite foil will be little different from the one having no dissimilar metal layer 6a, particularly when it is heat treated at above 400° C. Increasing thickness of the dissimilar metal layer 6a beyond 0.5 μm, on the other hand, will eliminate value of providing the other dissimilar metal layers 6b and 6c, because the effect of a combination of these dissimilar metal layers will be not different from that of the plated hard nickel layer alone. The dissimilar metal layer 6b (plated hard nickel layer) having a thickness below 0.3 μm will have little contribution to the effect of improving softening resistance characteristics by reinforcing the dissimilar metal layer 6a. Increasing thickness of the dissimilar metal layer 6b (plated hard nickel layer) beyond 2.5 μm, on the other hand, will diminish its economic efficiency to eliminate value of the three-layered structure. Moreover, the dissimilar metal layer 6c (second plated cobalt layer) having a thickness below 0.3 μm will have little contribution to improvement of oxidation-resistant characteristics and the effect of improving softening resistance characteristics by reinforcing the dissimilar metal layer 6b. Increasing thickness of the dissimilar metal layer 6c (second plated cobalt layer) beyond 2.5 μm, on the other hand, will diminish its economic efficiency to eliminate value of the three-layered structure.

The third composite foil 5c described above also has sufficient softening resistance and a tensile strength of 50 kgf/mm² or more even when heat-treated under conditions of 400° C. for 10 hours or so. Therefore, in use, it should show little deterioration in strength when treated at 300 to 400° C. for production of printed wiring boards with a substrate of fluorine resin, liquid-crystal polymer or the like. Accordingly, the capacitor layer forming material produced using the third composite foil 5c will show little deterioration in quality during manufacture.

The third composite foil described above is used for production of the capacitor layer forming material. The methods for producing the third composite foil described above and capacitor layer forming material will be described in detail later in the preferred embodiments.

<Method for Producing Composite Foil Used for Producing the Capacitor Layer Forming Material of the Present Invention>

Of the first composite copper foils described above, the one comprising a copper foil coated with a plated hard nickel layer as a dissimilar metal layer is preferably produced by a method which dips the copper foil in an electrolytic plating solution of hard nickel of the following composition, and electrolytically plates the foil under the following conditions to form a plated hard nickel layer on the foil.

[Hard Nickel Plating Solution Composition]

| | |
|---|---|
| NiSO₄.6H₂O | 100 to 180 g/L |
| NH₄Cl concentration | 20 to 30 g/L |
| H₃BO₃ concentration | 20 to 60 g/L |
| Solution temperature | 20 to 50° C. |
| pH | 3 to 5 |
| Current density | 1 to 50 A/dm² |
| Stirring | Adopted |

Of the first composite copper foils described above, the one comprising a copper foil coated with a plated cobalt layer as a dissimilar metal layer is preferably produced by a method which dips the copper foil in an electrolytic plating solution of cobalt sulfate of the following composition, and electrolytically plates the foil under the following conditions to form a plated cobalt layer on the foil. A coagulant is preferably incorporated at the concentration of 0.05 to 0.3 g/L in the electrolytic plating solution of cobalt sulfate.

[Cobalt Plating Solution Composition]

| | |
|---|---|
| CoSO₄.7H₂O | 120 to 200 g/L |
| H₃BO₃ | 25 to 50 g/L |
| Solution temperature | 20 to 50° C. |
| pH | 2 to 5 |
| Current density | 1 to 50 A/dm² |
| Stirring | Adopted |

Of the first composite copper foils described above, the one comprising a copper foil coated with a plated nickel/cobalt alloy layer as a dissimilar metal layer is preferably produced by a method which dips the copper foil in an electrolytic plating solution of nickel/cobalt alloy of the following composition, and electrolytically plates the foil under the following conditions to form a plated nickel/cobalt alloy layer on the foil.

[Nickel/cobalt alloy plating solution composition]

| | |
|---|---|
| NiSO₄.6H₂O | 100 to 200 g/L |
| NiCl₂.6H₂O | 30 to 50 g/L |
| CoSO₄.7H₂O | 10 to 30 g/L |
| H₃BO₃ | 20 to 40 g/L |
| Solution temperature | 20 to 50° C. |
| pH | 2 to 5 |
| Current density | 1 to 25 A/dm² |
| Stirring | Adopted |

Of the second composite copper foils described above, the one comprising a copper foil coated with 2 layers of plated cobalt and plated hard nickel as dissimilar metal layers is preferably produced by a method which first dips the copper foil in an electrolytic plating solution of cobalt sulfate of the following composition and electrolytically plates the foil under the following conditions (Solution composition and electrolysis conditions A) to form a plated cobalt layer on the foil, and then dips the coated copper foil an electrolytic plating solution of hard nickel of the following composition and electrolytically plates the coated foil under the following conditions (Solution composition and electrolysis conditions B) to form a plated hard nickel layer on the cobalt layer. A coagulant is preferably incorporated at the concentration of 0.05 to 0.3 g/L in the electrolytic plating solution of cobalt sulfate.

[Solution Composition and Electrolysis Conditions A]

| | |
|---|---|
| CoSO₄.7H₂O | 120 to 200 g/L |
| H₃BO₃ | 25 to 50 g/L |
| Solution temperature | 20 to 50° C. |
| pH | 2 to 5 |
| Current density | 1 to 50 A/dm² |
| Stirring | Adopted |

[Solution Composition and Electrolysis Conditions B]

| | |
|---|---|
| NiSO₄.6H₂O | 100 to 180 g/L |
| NH₄Cl concentration | 20 to 30 g/L |
| H₃BO₃ concentration | 20 to 60 g/L |
| Solution temperature | 20 to 50° C. |
| pH | 4 to 5 |
| Current density | 1 to 50 A/dm² |
| Stirring | Adopted |

Of the second composite copper foils described above, the one comprising a copper foil coated with 2 layers of plated iron and plated hard nickel as dissimilar metal layers is preferably produced by a method which first dips the copper foil in an electrolytic plating solution of iron sulfate of the following composition and electrolytically plates the foil under the following conditions (Solution composition and electrolysis conditions A) to form a plated iron layer on the foil, and then dips the coated copper foil in an electrolytic plating solution of hard nickel of the following composition and electrolytically plates the coated foil under the following conditions (Solution composition and electrolysis conditions B) to form a plated hard nickel layer on the plated iron layer. A coagulant is preferably incorporated at the concentration of 0.05 to 0.3 g/L in the electrolytic plating solution of iron sulfate.

[Solution Composition and Electrolysis Conditions A]

| | |
|---|---|
| FeSO₄.7H₂O | 100 to 200 g/L |
| H₃BO₃ | 25 to 50 g/L |
| Solution temperature | 20 to 50° C. |
| pH | 2 to 5 |
| Current density | 1 to 30 A/dm² |
| Stirring | Adopted |

[Solution Composition And Electrolysis Conditions B]

| | |
|---|---|
| NiSO₄.6H₂O | 100 to 180 g/L |
| NH₄Cl concentration | 20 to 30 g/L |
| H₃BO₃ concentration | 20 to 60 g/L |
| Solution temperature | 20 to 50° C. |
| pH | 4 to 5 |
| Current density | 1 to 50 A/dm² |
| Stirring | Adopted |

Of the third composite copper foils described above, the one comprising a copper foil coated with 3 layers of plated cobalt (first cobalt layer), plated hard nickel and plated cobalt (second cobalt layer) as dissimilar metal layers is preferably produced by a method which first dips the copper foil in an electrolytic plating solution of cobalt sulfate of the following composition and electrolytically plates the foil under the following conditions (Solution composition and electrolysis conditions A) to form a first plated cobalt layer on the foil, then dips the coated copper foil in an electrolytic plating solution of hard nickel of the following composition and electrolytically plates the coated foil under the following conditions (Solution composition and electrolysis conditions B) to form a plated hard nickel layer on the first plated cobalt layer, and then dips the coated copper foil in an electrolytic plating solution of cobalt sulfate of the following composition and electrolytically plates the coated foil under the following conditions (Solution composition and electrolysis conditions A) to form a second plated cobalt layer on the plated hard nickel layer. A coagulant is preferably incorporated at the concentration of 0.05 to 0.3 g/L in the electrolytic plating solution of cobalt sulfate.

[Solution Composition and Electrolysis Conditions A]

| | |
|---|---|
| CoSO₄.7H₂O | 120 to 200 g/L |
| H₃BO₃ | 25 to 50 g/L |
| Solution temperature | 20 to 50° C. |
| pH | 2 to 5 |
| Current density | 1 to 50 A/dm² |
| Stirring | Adopted |

[Solution Composition and Electrolysis Conditions B]

| | |
|---|---|
| NiSO₄.6H₂O | 100 to 180 g/L |
| NH₄Cl concentration | 20 to 30 g/L |
| H₃BO₃ concentration | 20 to 60 g/L |
| Solution temperature | 20 to 50° C. |
| pH | 4 to 5 |
| Current density | 1 to 50 A/dm² |
| Stirring | Adopted |

Of the third composite copper foils described above, the one comprising a copper foil coated with 3 layers of plated iron, plated hard nickel and plated cobalt as dissimilar metal layers is preferably produced by a method which first dips the copper foil in an electrolytic plating solution of iron sulfate of the following composition and electrolytically plates the foil under the following conditions (Solution composition and electrolysis conditions A) to form a plated iron layer on the foil, then dips the coated copper foil in an electrolytic plating solution of hard nickel of the following composition and electrolytically plates the coated foil under the following conditions (Solution composition and electrolysis conditions B) to form a plated hard nickel layer on the plated iron layer, and then dips the coated copper foil in an electrolytic plating solution of cobalt sulfate of the following composition and electrolytically plates the coated foil under the following conditions (Solution composition and electrolysis conditions C) to form a plated cobalt layer on the plated hard nickel layer. A coagulant is preferably incorporated at the concentration of 0.05 to 0.3 g/L in the electrolytic plating solution of cobalt sulfate.

[Solution Composition and Electrolysis Conditions A]

| | |
|---|---|
| FeSO₄.7H₂O | 100 to 200 g/L |
| H₃BO₃ | 20 to 50 g/L |
| Solution temperature | 20 to 50° C. |
| pH | 2 to 5 |
| Current density | 1 to 30 A/dm² |
| Stirring | Adopted |

[Solution Composition and Electrolysis Conditions B]

| | |
|---|---|
| NiSO₄.6H₂O | 100 to 180 g/L |
| NH₄Cl concentration | 20 to 30 g/L |
| H₃BO₃ concentration | 20 to 60 g/L |
| Solution temperature | 20 to 50° C. |
| pH | 4 to 5 |
| Current density | 1 to 50 A/dm² |
| Stirring | Adopted |

[Solution Composition and Electrolysis Conditions C]

| | |
|---|---|
| CoSO₄.7H₂O | 120 to 200 g/L |
| H₃BO₃ | 20 to 50 g/L |
| Solution temperature | 20 to 50° C. |
| pH | 2 to 5 |
| Current density | 1 to 50 A/dm² |
| Stirring | Adopted |

<Printed Wiring Board Provided with a Built-In Capacitor Circuit>

A printed wiring board provided with a built-in capacitor circuit, for which one of the capacitor layer forming materials of the present invention is used, may be produced by various methods. The printed wiring board falls into one of the variations, described below.

Variation P1: The printed wiring board provided with a built-in capacitor circuit which is made of the capacitor layer forming material comprising the first electroconductive layer used for forming an upper electrode and second electroconductive layer used for forming a lower electrode with the dielectric layer in-between, wherein the second electroconductive layer is made of the composite foil comprising a copper layer coated with a plated hard nickel layer as the dissimilar metal layer.

Variation P2: The printed wiring board provided with a built-in capacitor circuit which is made of the capacitor layer forming material comprising the first electroconductive layer used for forming an upper electrode and second electroconductive layer used for forming a lower electrode with the dielectric layer in-between, wherein the second electroconductive layer is made of the composite foil comprising a copper layer coated with a plated cobalt layer as the dissimilar metal layer.

Variation P3: The printed wiring board provided with a built-in capacitor circuit which is made of the capacitor layer forming material comprising the first electroconductive layer used for forming an upper electrode and second electroconductive layer used for forming a lower electrode with the dielectric layer in-between, wherein the second electroconductive layer is made of the composite foil comprising a copper layer coated with a plated nickel/cobalt layer as the dissimilar metal layer.

Variation P4: The printed wiring board provided with a built-in capacitor circuit which is made of the capacitor layer forming material comprising the first electroconductive layer used for forming an upper electrode and second electroconductive layer used for forming a lower electrode with the dielectric layer in-between, wherein the second electroconductive layer is made of the composite foil comprising a copper layer coated with 2 layers of plated cobalt and plated hard nickel, in this order, as the dissimilar metal layers.

Variation P5: The printed wiring board provided with a built-in capacitor circuit which is made of the capacitor layer forming material comprising the first electroconductive layer used for forming an upper electrode and second electroconductive layer used for forming a lower electrode with the dielectric layer in-between, wherein the second electroconductive layer is made of the composite foil comprising a copper layer coated with 2 layers of plated iron and plated hard nickel, in this order, as the dissimilar metal layers.

Variation P6: The printed wiring board provided with a built-in capacitor circuit which is made of the capacitor layer forming material comprising the first electroconductive layer used for forming an upper electrode and second electroconductive layer used for forming a lower electrode with the dielectric layer in-between, wherein the second electroconductive layer is made of the composite foil comprising a copper layer coated with 3 layers of plated cobalt, plated hard nickel and plated cobalt, in this order, as the dissimilar metal layers.

Variation P7: The printed wiring board provided with a built-in capacitor circuit which is made of the capacitor layer forming material comprising the first electroconductive layer used for forming an upper electrode and second electroconductive layer used for forming a lower electrode with the dielectric layer in-between, wherein the second electroconductive layer is made of the composite foil comprising a copper layer coated with 3 layers of plated iron, plated hard nickel and plated cobalt, in this order, as the dissimilar metal layers.

The above-described capacitor circuit built in the printed wiring board will have no abnormality in the lower electrode shape and will withstand expansion/contraction induced by heat from the surrounding materials, even when exposed cyclically to hot pressing carried out at 300 to 400° C. These desirable properties are present because the second electroconductive layer, which constitutes the lower electrode comprising the composite foil is highly resistant to heat and has resistivity to expansion and contraction induced by heat from the surrounding materials. It is therefore suitable for forming a capacitor circuit to be built in a multilayer printed wiring board with a substrate of Teflon or liquid-crystal polymer.

The capacitor layer forming material of the present invention is provided with the highly heat-resistant composite foil for the second electroconductive layer which constitutes the lower electrode. Therefore, the capacitor circuit of the above material will retain its shape and will withstand expansion and contraction induced by heat from the surrounding materials, even when exposed cyclically to hot pressing carried out at 300 to 400° C., used for production of a multilayer printed wiring board with a substrate of Teflon or liquid-crystal polymer. Moreover, by selecting the type and structure of the layers of the dissimilar metals in the composite foil in accordance with the dielectric layer type, high adhesivness of the two is achieved. Thus, by incorporating a capacitor circuit composed of the herein described capacitor layer forming material into a printed circuit board, the sought advantageous qualities described above are found. Finally, manufacture of the composite foil for production of the capacitor layer forming material of the present invention can be performed by plating copper foil with one or more heat-resistant dissimilar metal layers, a common procedure.

### BRIEF DESCRIPTION OF THE DRAWINGS

FIGS. 1, 3 and 9 are cross-sectional views schematically illustrating a capacitor layer forming material of the present invention;

FIGS. 2, 4 and 10 are cross-sectional views schematically illustrating a composite foil used for producing a capacitor layer forming material of the present invention;

FIG. 5 is an optical microgram of composite foil under the normal state, comprising a copper foil coated with a plated cobalt and hard nickel layers, in this order;

FIG. 6 is an optical microgram of composite foil comprising a copper foil coated with a plated cobalt and hard nickel layers, in this order, heated at 400° C. for 10 hours;

FIG. 7 is an optical microgram of composite foil under the normal state, comprising a copper foil coated with a plated hard nickel layer;

FIG. 8 is an optical microgram of composite foil comprising a copper foil coated with a plated hard nickel layer, heated at 400° C. for 10 hours; and

FIGS. 11 to 14 schematically illustrate a production flow of a printed wiring board provided with a built-in capacitor circuit in which a capacitor layer forming material of the present invention is used.

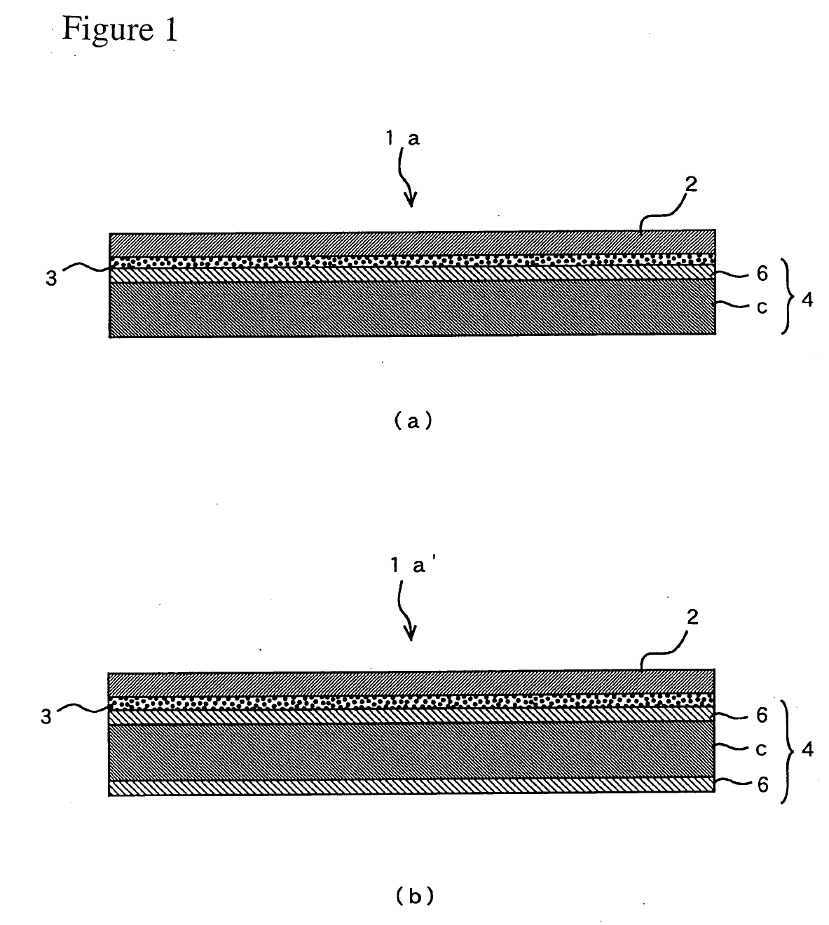

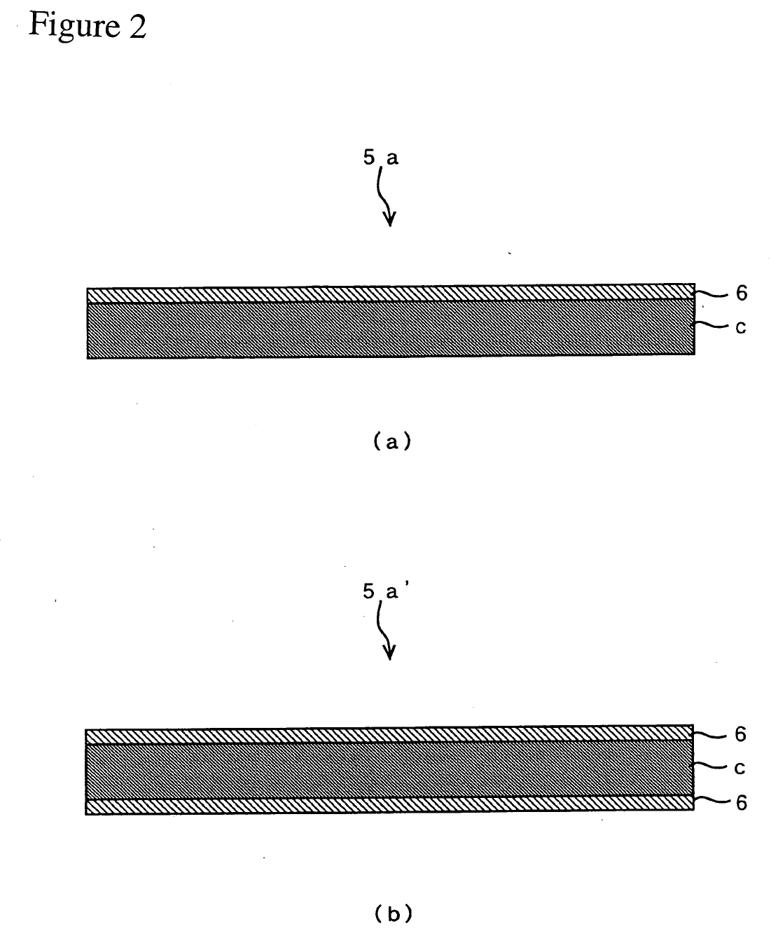

### DETAILED DESCRIPTION OF THE PREFERRED EMBODIMENTS

Embodiments of production of each composite foil for the present invention and capacitor layer forming material of the present invention are described. Moreover, production of the printed wiring board with a built-in capacitor circuit is described in Examples.

<Embodiments of Production of Composite Foils>

First composite foil (1): Of the first composite copper foils, the one comprising a copper foil coated with a plated hard nickel layer as a dissimilar metal layer is preferably produced by a method which employs an electrolytic plating solution of hard nickel of the composition described above, because it produces the plated hard nickel layer with preferable softening resistance following treatment at high temperatures. The electrolytic plating solution of hard nickel used for the present invention has a composition close to a Watt solution. It is simpler in composition than a commonly used Watt solution, but allows the electrolysis to proceed stably. It is characterized by use of a nickel and ammonium salts simultaneously.

The NiSO₄.6H₂O concentration of the plating solution is preferably in a range from 100 to 180 g/L. At below 100 g/L, the plating solution contains nickel at an insufficient concentration for satisfactory commercial productivity, and will give a plated layer of insufficient smoothness. On the other hand, increasing the concentration beyond 180 g/L will no longer significantly increase hard nickel deposition rate but merely increases the waste treatment load.

H₃BO₃ works as a buffer agent, and is preferably contained in the solution at the concentration of 20 to 60 g/L. H₃BO₃ concentration is determined in accordance with NiSO₄.6H₂O concentration. The plated hard nickel layer will have an insufficient strength, when the concentration is outside of the above range.

Solution temperature can be selected from a wide range from 20 to 50° C., because the resulting plated layer is less sensitive to solution temperature than that produced in a commonly used nickel acetate or sulfamic acid solution. The solution of the above composition can be kept at a pH level of 3 to 5 in order to obtain a plating film with stable and most excellent tensile strength. Current density for plating can be selected from a wide range from 1 to 50 A/dm², because the resulting plated layer is less sensitive in tensile strength to current density than that produced in a commonly used nickel acetate solution. Current density is preferably 4 A/dm² or less or 10 A/dm² or more. While in this range the tensile strength can be lower than at other current densities, the range of 4 to 10 A/dm² is preferable when importance is placed on constant product quality. Current density outside this range but within 1 to 50 A/dm² is preferable when maximal tensile strength of the plated hard nickel layer is desired. The above description is based on the assumption that the plating solution is stirred in the bath. The term stirring used in this specification means stirring to an extent to prevent formation of an ion-depleted layer around the surface to be plated by electrode position. The concept of stirring includes a fluidized stirring condition generated by circulation of the plating solution in a plating tank equipped with a stirrer.

First composite foil (2): Of the first composite copper foils described above, the one comprising a copper foil coated with a plated cobalt layer as a dissimilar metal layer can be produced by various methods, so long as a plated cobalt layer can be formed on the copper foil. For example, the cobalt layer can be formed using cobalt sulfate under the following conditions, a) cobalt concentration: 5 to 30 g/L, trisodium citrate concentration: 50 to 500 g/L, solution temperature: 20 to 50° C., solution pH: 2 to 4 and current density: 0.3 to 10 A/dm², b) cobalt concentration: 5 to 30 g/L, potassium pyrophosphate concentration: 50 to 500 g/L, solution temperature: 20 to 50° C., solution pH: 8 to 11 and current density: 0.3 to 10 A/dm², and c) cobalt concentration: 10 to 70 g/L, boric acid concentration: 20 to 60 g/L, solution temperature: 20 to 50° C., solution pH: 2 to 4 and current density: 1 to 50 A/dm².

However, use of the electrolytic plating solution of cobalt sulfate of the above-described composition is most preferable for the present invention, because it gives the plated cobalt layer of highest softening resistance characteristics after it is treated at high temperature. This embodiment uses an electrolytic plating solution of cobalt sulfate, which is the nickel sulfate solution for producing the plated hard nickel layer for the first composite foil (1) with nickel sulfate replaced by cobalt sulfate, and is incorporated with a coagulant.

The CoSO₄.7H₂O concentration of the plating solution is preferably in a range from 120 to 200 g/L. At below 120 g/L, the plating solution contains cobalt at an insufficient concentration for satisfying commercial productivity, and will give a plated layer of insufficient smoothness. On the other hand, increasing the concentration beyond 200 g/L will no longer significantly increase cobalt deposition rate but merely increases the waste treatment load.

H₃BO₃ works as a buffer agent similarly to the first composite foil, and is preferably contained in the solution at the concentration of 25 to 50 g/L. H₃BO₃ concentration is determined in accordance with CoSO₄.7H₂O concentration. The plated cobalt layer itself will have an insufficient strength, when the concentration is outside of the above range.

Solution temperature can be selected from a wide range from 20 to 50° C. In the case of the plated cobalt layer, decreasing solution temperature tends to increase tensile strength of the layer. However, solution temperature below 20° C. will fail to satisfy commercial productivity, because of low cobalt deposition rate. At around 50° C., on the other hand, tensile strength of the layer tends to become saturated, showing little increase as temperature further increases. The solution of the above composition can give the plated layer of highest, most stable tensile strength, when kept at a pH level of 2 to 5. Current density for plating can be selected from a wide range from 1 to 50 A/dm², because tensile strength of the plated layer is not sensitive to current density. Current density is preferably 2 A/dm² or less or 8 A/dm² or more, in particular for increasing tensile strength of the plated cobalt layer itself. Tensile strength of the plated cobalt layer produced at a current density of 2 to 8 A/dm² does not fluctuate much and tends to remain at a constant level, although tending to be lower than that of the layer produced at another current density level in the above preferable range. It is therefore preferable to select a current density in a range from 2 to 8 A/dm², when importance is placed on securing constant product quality. The above description is based on the assumption that the plating solution is stirred in the bath.

It is also preferable to incorporate a coagulant in the cobalt plating solution. The coagulant may be selected from commercial ones. The particularly preferable ones are those containing an acrylamide-based polymer as the major component. The coagulant is used to control cobalt deposition rate and thereby to improve uniformity of plated layer thickness. It is incorporated in the plating solution at a concentration of 0.05 to 0.3 g/L. At below 0.05 g/L, it may not contribute to improvement of uniformity of plated cobalt layer thickness. Increasing the concentration beyond 0.3 g/L may conversely deteriorate uniformity of plated cobalt layer thickness.

First composite foil (3): Of the first composite copper foils described above, the one comprising a copper foil coated with a plated nickel/cobalt layer as a dissimilar metal layer can employ various plating conditions, so long as a plated nickel/cobalt layer can be formed on the copper foil. For example, the nickel/cobalt layer can be formed under the following conditions, cobalt sulfate concentration: 80 to 180 g/L, nickel sulfate concentration: 80 to 120 g/L, boric acid concentration: 20 to 40 g/L, potassium chloride concentration: 10 to 15 g/L, sodium dihydrogen phosphate concentration: 0.1 to 15 g/L, solution temperature: 30 to 50° C., solution pH: 3.5 to 4.5, and current density: 1 to 10 A/dm².

However, use of the above-described electrolytic plating solution of nickel/cobalt alloy containing sodium formate is preferable for the present invention to secure good softening resistance characteristics of the composite foil, because it gives the plated nickel/cobalt alloy layer of highest softening resistance characteristics after it is treated at high temperature. The electrolytic plating solution of nickel/cobalt alloy used for the present invention has a composition, e.g., Watt composition with cobalt sulfate incorporated therein in plating nickel. Therefore, the composition is very simple and allows the electrolysis to proceed stably.

The electrolytic plating solution of nickel/cobalt alloy preferably contains NiSO₄.6H₂O at 100 to 200 g/L, NiCl₂.6H₂O at 30 to 50 g/L and CoSO₄.7H₂O at 10 to 30 g/L. The solution of the above composition can give the plated nickel/cobalt alloy layer having highest softening resistance characteristics after it is treated at high temperature. A nickel/cobalt alloy layer may not have highest softening resistance characteristics after it is treated at high temperature, when plated in a solution with any component outside of its compositional range, described above.

H₃BO₃ works as a buffer agent also in this embodiment, and is preferably contained in the solution at 20 to 40 g/L. H₃BO₃ concentration is determined in accordance with each of NiSO₄.6H₂O, NiCl₂.6H₂O and CoSO₄.7H₂O concentrations. The plated nickel/cobalt alloy layer itself will have an insufficient strength and deteriorated thickness uniformity, when the concentration of each component is outside of the above range.

Solution temperature can be selected from a range of 20 to 50° C. Also in the case of the plated nickel/cobalt alloy layer, decreasing solution temperature tends to increase tensile strength of the layer. However, solution temperature below 20° C. will fail to satisfy commercial productivity, because of low nickel/cobalt alloy deposition rate. At around 50° C., on the other hand, tensile strength of the layer tends to become saturated, showing little increase as temperature further increases. The solution of the above composition can give the plated layer of highest, most stable tensile strength, when kept at a pH level of 2 to 5. Current density for plating can be selected from a wide range from 1 to 25 A/dm². The plated nickel/cobalt alloy layer will have reduced fluctuations in nickel and cobalt contents, and also minimized tensile strength fluctuation, when produced at a current density in the above range. A current density not more than 10 A/dm² is more preferable to increase tensile strength of the plated nickel/cobalt alloy layer itself. The above description is based on the assumption that the plating solution is stirred in the bath.

It is also preferable for the present invention to incorporate sodium formate (HCOONa) in the solution for forming the plated nickel/cobalt alloy layer. It is known that sodium formate, when used for forming a plated chromium layer, reduces the hexavalent chromium ion to the trivalent state in the plating solution which helps to deposit the chromium thus improving hardness. When used for forming a plated nickel/cobalt alloy layer, as in the case of the present invention, sodium formate works as a reducing agent for metallic ions dissolved in a plating solution, which improves deposition. This gives the plated alloy layer a uniform composition by reducing uneven distributions of these components dispersed in the layer. It is preferably incorporated in the solution at the concentration of 25 to 50 g/L. At below 25 g/L, a uniformly mixed condition of the nickel and cobalt components may not be secured in the plated alloy layer. Increasing the concentration beyond 50 g/L, on the other hand, may not further improve uniformity of the plated nickel/cobalt alloy layer.

Second composite foil (1): Of the second composite foils described above, the one comprising a copper foil coated with 2 layers of plated cobalt and plated hard nickel as dissimilar metal layers is produced by a method which first dips the copper foil in an electrolytic plating solution of cobalt sulfate of the composition A and electrolytically plates the foil under the conditions A to form a plated cobalt layer on the foil, and then dips the coated copper foil in an electrolytic plating solution of hard nickel of the composition B and electrolytically plates the coated foil under the conditions B to form a plated hard nickel layer on the cobalt layer, the compositions A and B and conditions A and B being described earlier.

The electrolytic plating solution of cobalt sulfate is similar to the one for the above-described first composite foil (2), and the electrolytic plating solution of hard nickel is similar to the one for the above-described first composite foil (1). Therefore, their descriptions are omitted to avoid duplication.

Second composite foil (2): Of the second composite foils described above, the one comprising a copper foil coated with 2 layers of plated iron and plated hard nickel as dissimilar metal layers is produced by a method which first dips the copper foil in an electrolytic plating solution of iron sulfate of the composition A and electrolytically plates the foil under the conditions A to form a plated iron layer on the foil, and then dips the coated copper foil in an electrolytic plating solution of hard nickel of the composition B and electrolytically plates the coated foil under the conditions B to form a plated hard nickel layer on the iron layer, the compositions A and B and conditions A and B being described earlier.

The electrolytic plating solution of hard nickel is similar to the one for the above-described first composite foil (1). Therefore, its description is omitted to avoid duplication, and only the plating solution of iron is described below.

The FeSO₄.7H₂O concentration of the plating solution is preferably in a range from 100 to 200 g/L. At below 100 g/L, the plating solution contains iron at an insufficient concentration to give a plated layer of sufficient smoothness. On the other hand, increasing the concentration beyond 200 g/L will no longer significantly increase iron deposition rate but merely increases the waste treatment load.

H₃BO₃ works as a buffer agent as in the case with production of the first composite foil, and is preferably contained in the solution at 20 to 50 g/L. H₃BO₃ concentration is determined in accordance with FeSO₄.7H₂O concentration. The plated iron layer becomes brittle, when the concentration is outside of the above range.

Solution temperature can be selected from a wide range from 20 to 50° C. Solution temperature below 20° C. will fail to satisfy commercial productivity, because of low iron deposition rate. Increasing temperature beyond 50° C., on the other hand, will deteriorate solution service life increasing costs. The solution of the above composition can give the plated layer of highest, most stable tensile strength, when kept at a pH level of 2 to 5. Current density for plating can be selected from a wide range from 1 to 30 A/dm², because tensile strength of the plated layer is not sensitive to current density. Current density is preferably 2 A/dm² or less or 8 A/dm² or more, in particular for simultaneously increasing hardness and tensile strength of the plated iron layer itself. Tensile strength of the plated iron layer produced at a current density of 2 to 8 A/dm² does not fluctuate much and tends to remain at a constant level, although tending to be lower than that of the layer produced at another current density level in the above preferable range. It is therefore preferable to select a current density in a range from 2 to 8 A/dm², when importance is placed on securing product quality stability. The above description is based on the assumption that the plating solution is stirred in the bath.

It is also preferable to incorporate a coagulant in the iron plating solution. The coagulant may be selected from commercial ones. The particularly preferable ones are those containing an acrylamide-based polymer as the major component. The coagulant is used to control iron deposition rate and thereby to improve uniformity of plated layer thickness. It is incorporated in the plating solution at a concentration of 0.05 to 0.3 g/L. At below 0.05 g/L, it may not contribute to improvement of uniformity of plated iron layer thickness. Increasing the concentration beyond 0.3 g/L may conversely deteriorate uniformity of plated cobalt or plated iron layer thickness.

Third composite foil (1): Of the third composite foils described above, the one comprising a copper foil coated with 3 layers of plated cobalt (first cobalt layer), plated hard nickel and plated cobalt (second cobalt layer), in this order, as the dissimilar metal layers is produced by a method which first dips the copper foil in an electrolytic plating solution of cobalt sulfate of the composition A and electrolytically plates the foil under the conditions A to form a plated first cobalt layer on the foil, then dips the coated copper foil in an electrolytic plating solution of hard nickel of the composition B and electrolytically plates the coated foil under the conditions B to form a plated hard nickel layer on the first cobalt layer, and then dips the coated foil in an electrolytic plating solution of cobalt sulfate of the composition A and electrolytically plates the foil under the conditions A to form a plated cobalt layer (second cobalt layer) on the plated hard nickel layer, the compositions A and B and conditions A and B being described earlier.

The electrolytic plating solution of cobalt sulfate is similar to the one for the above-described first composite foil (2), and the electrolytic plating solution of hard nickel is similar to the one for the above-described first composite foil (1). Therefore, their descriptions are omitted to avoid duplication.

Third composite foil (2): Of the third composite foils described above, the one comprising a copper foil coated with 3 layers of plated iron, plated hard nickel and plated cobalt layers, in this order, as the dissimilar metal layers is produced by a method which first dips the copper foil in an electrolytic plating solution of iron sulfate of the composition A and electrolytically plates the foil under the conditions A to form a plated iron layer on the foil, then dips the coated copper foil in an electrolytic plating solution of hard nickel of the composition B and electrolytically plates the coated foil under the conditions B to form a plated hard nickel layer on the iron layer, and then dips the coated foil in an electrolytic plating solution of cobalt sulfate of the composition C and electrolytically plates the foil under the conditions C to form a plated cobalt layer on the plated hard nickel layer, the compositions A, B and C, and conditions A, B and C being described earlier.

The electrolytic plating solution of iron sulfate is similar to the one for the above-described second composite foil (2), the electrolytic plating solution of hard nickel is similar to the one for the above-described first composite foil (1), and electrolytic plating solution of cobalt sulfate is similar to the one for the above-described first composite foil (2). Therefore, their descriptions are omitted to avoid duplication.

<Embodiment of Production of Capacitor Layer Forming Material of the Present Invention>

The method for forming the capacitor layer forming materials which includes one of the composite foils described above, involves forming a dielectric layer on the dissimilar metal layer side of the composite foil. The material for the dielectric layer is not limited. The method for forming the dielectric layer may be selected from various known ones, including the so-called sol-gel method, coating the composite foil with a resin solution containing a dielectric filler and binder resin, and lamination of films containing a dielectric filler. The first electroconductive layer for forming the upper electrode is then formed on the dielectric layer. The method for forming the first electroconductive layer may be selected from various known ones, including lamination of metal foils, plating for forming the electroconductive layer and sputtering deposition.

<Embodiment of Production of Printed Wiring Board with Built-In Capacitor Circuit for which the Capacitor Layer Forming Material of the Present Invention is Used>

A lower electrode, highly adhesive to the dielectric layer can, be formed by use of the capacitor layer forming material of the present invention as described above. The lower electrode is made of a highly heat-resistant material, and hence is resistant to oxidation-induced aging and deterioration of properties, even when exposed cyclically to hot pressing carried out at 300 to 400° C. The method is not limited for producing a printed wiring board with a built-in capacitor circuit for which the capacitor layer forming material of the present invention is used, and may be selected from various ones. However, it is preferable to adopt a method which can produce a printed wiring board with minimized number of dielectric layers except in the capacitor circuit section, as discussed in Examples described below.

### EXAMPLE 1

Example 1 produced the first composite foil provided with a plated hard nickel layer, capacitor layer forming material using the first composite foil, and printed wiring board with a built-in capacitor circuit.

<Production of the First Composite Foil>

An electrolytic copper foil (thickness: 12 μm, VLP foil, Mitsui Mining & Smelting) was dipped in an electrolytic plating solution of hard nickel of the following composition, and plated under the following conditions to form a plated hard nickel layer on the foil, to a thickness of 2 μm on the glossy surface and to a thickness equivalent to 3 μm on the rough surface. The resulting first composite foil had a total thickness of 17.5 μm. Thickness of the dissimilar metal layer, described in this specification, means the value based on the coating weight for forming the layer of given thickness on a flat surface by plating. Thickness of the actually produced composite foil means gauge thickness. The same applies to the composite foils produced in all Examples and Comparative Examples.

(Hard Nickel Plating Solution Composition)

| | |
|---|---|
| NiSO₄.6H₂O | 162 g/L |
| NH₄Cl | 25 g/L |
| H₃BO₃ | 30 g/L |

(Plating Conditions)

| | |
|---|---|
| Solution temperature | 35° C. |
| pH | 4 |
| Current density | 10 A/dm² |
| Stirring | Adopted |

The first composite foil produced above was analyzed for its tensile strength and elongation under the normal state and after it was treated at 400° C. for 10 hours under a vacuum. The results are given in Table 1. These properties were analyzed in accordance with IPC-TM-650 in IPC-MF-150F for a copper foil in a printed wiring board. The same applies to the composite foils produced in all Examples and Comparative Examples.

<Production of Capacitor Layer Forming Material>

The above-described first composite foil was used for forming the second electroconductive layer for forming the lower electrode in the capacitor layer forming material. The first composite foil was coated with a dielectric layer by a sol-gel method on the plated hard nickel layer side.

The sol-gel method adopted in this embodiment used a sol-gel solution of methanol heated at temperature close to its boiling point, and incorporated with ethanolamine as a stabilizer at 50 to 60% by mol on the total metals, titanium isopropoxide, propanol solution of zirconium propoxide, lead acetate, lanthanum acetate and nitric acid as a catalyst, in this order, and finally diluted with methanol to 0.2 mols/L. This sol-gel solution was spread by a spin coater on the plated hard nickel layer on the surface-treated copper foil, described above, dried at 250° C. for 5 minutes in the atmosphere, and thermally decomposed at 500° C. for 15 minutes also in the atmosphere. This coating procedure was repeated 6 times to adjust layer thickness. Then, it was finally fired at 600° C. for 30 minutes in a nitrogen substituted atmosphere to form the dielectric layer. The dielectric layer had a composition ratio Pb/La/Zr/Ti of 1.1/0.05/0.52/0.48. The dielectric layer itself showed no abnormality.

A 3 μm thick copper layer was formed as the first electroconductive layer on the dielectric layer produced above by sputtering deposition. This formed the capacitor layer forming material comprising the first and second electroconductive layers with the dielectric layer in-between. At this stage, a given voltage was applied to the capacitor layer forming material for observing interlayer voltage withstanding. No short-circuit phenomenon was observed between the first and second electroconductive layers.

<Production of Printed Wiring Board>

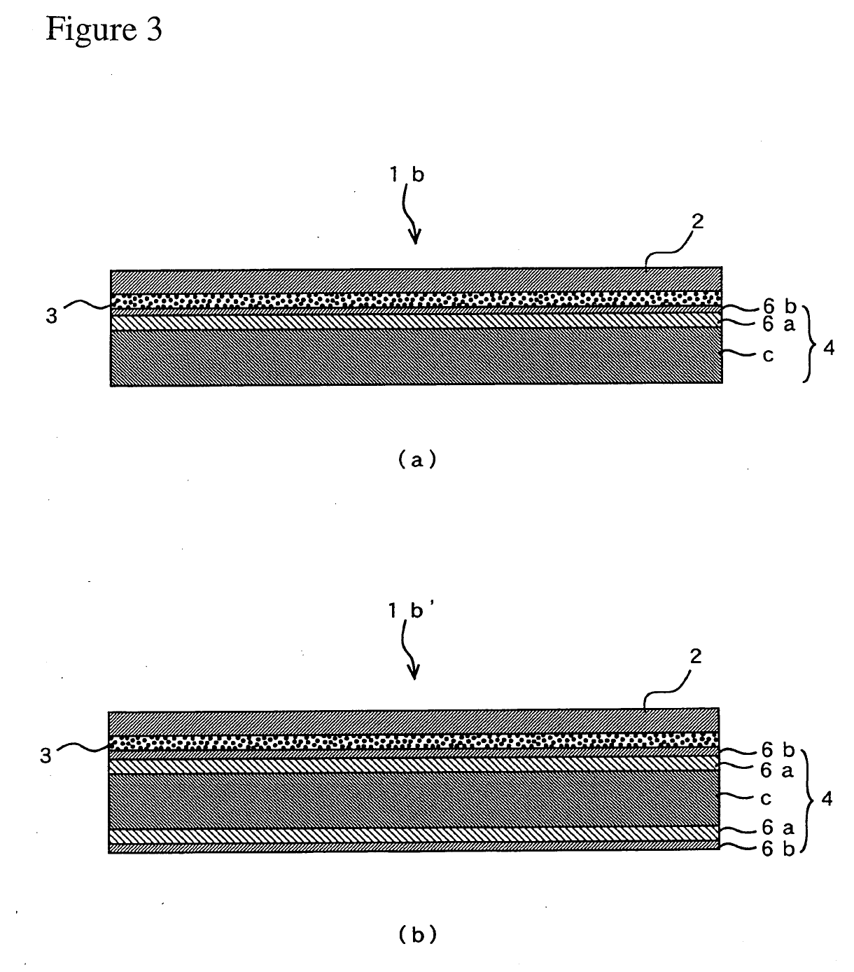

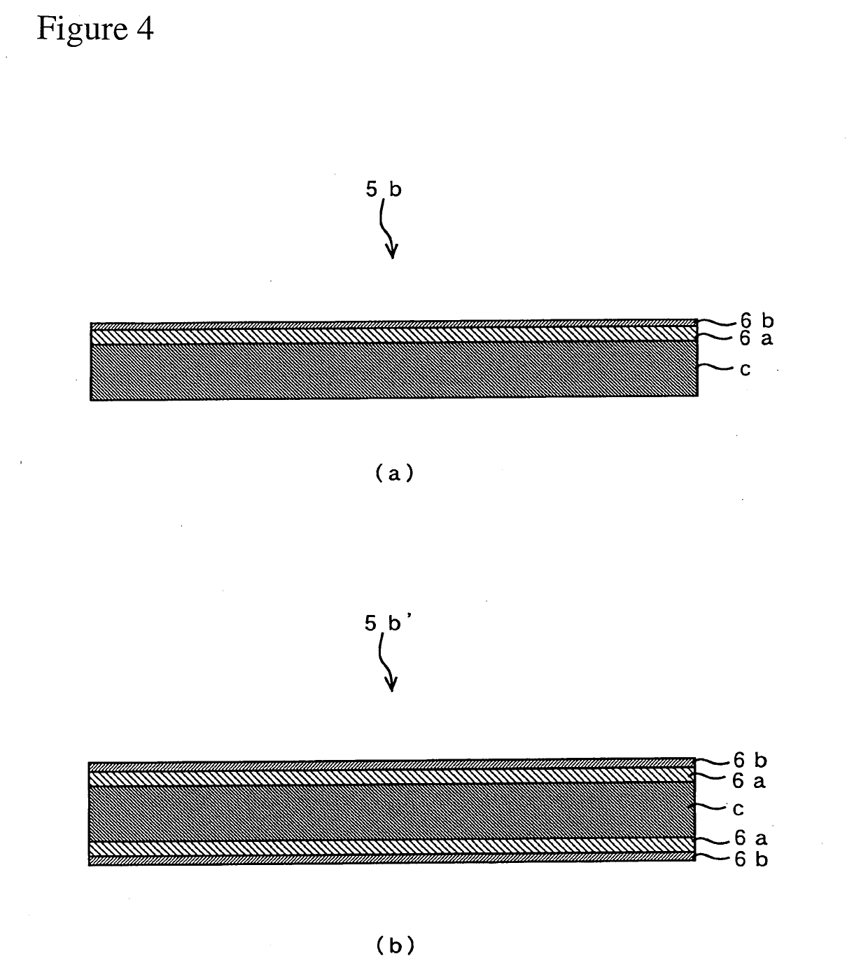

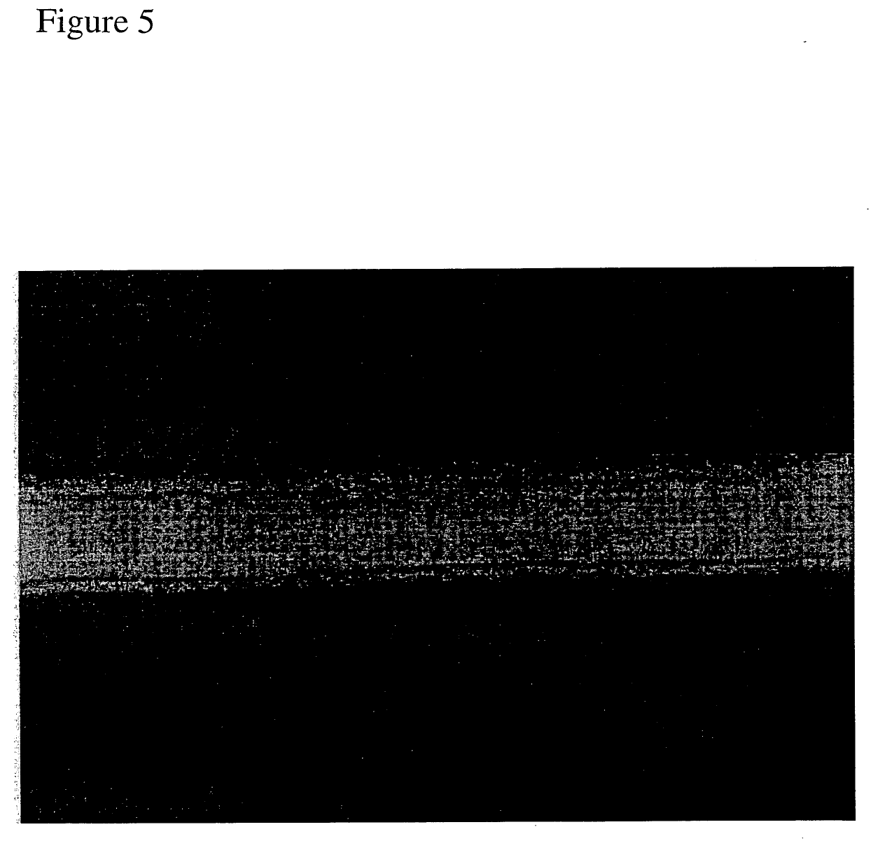

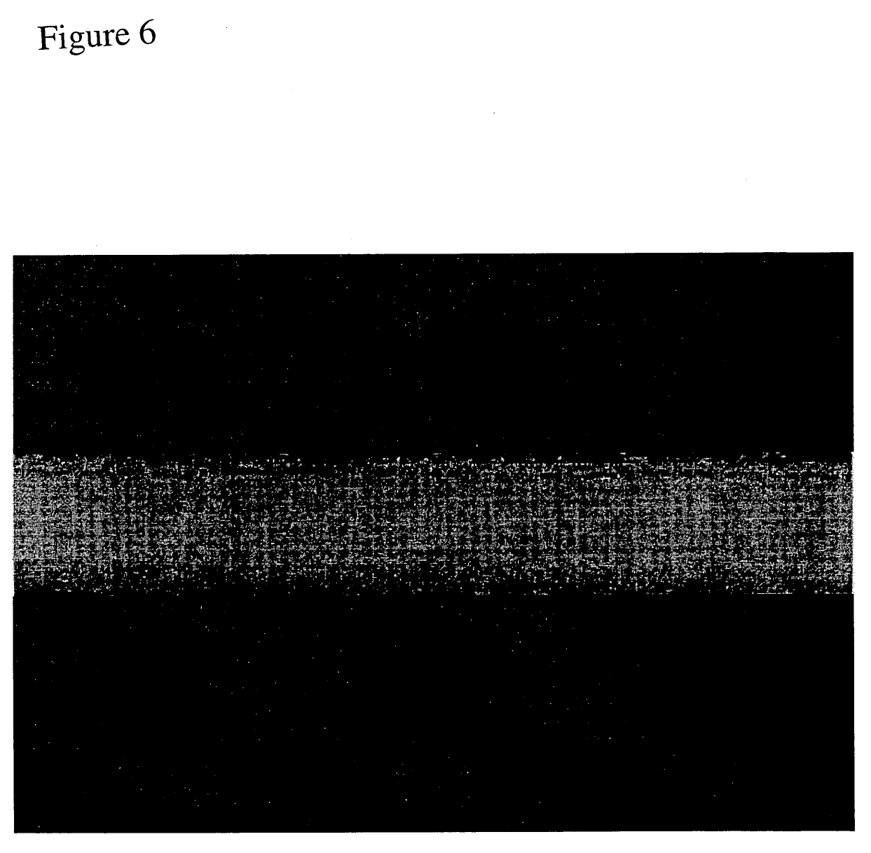

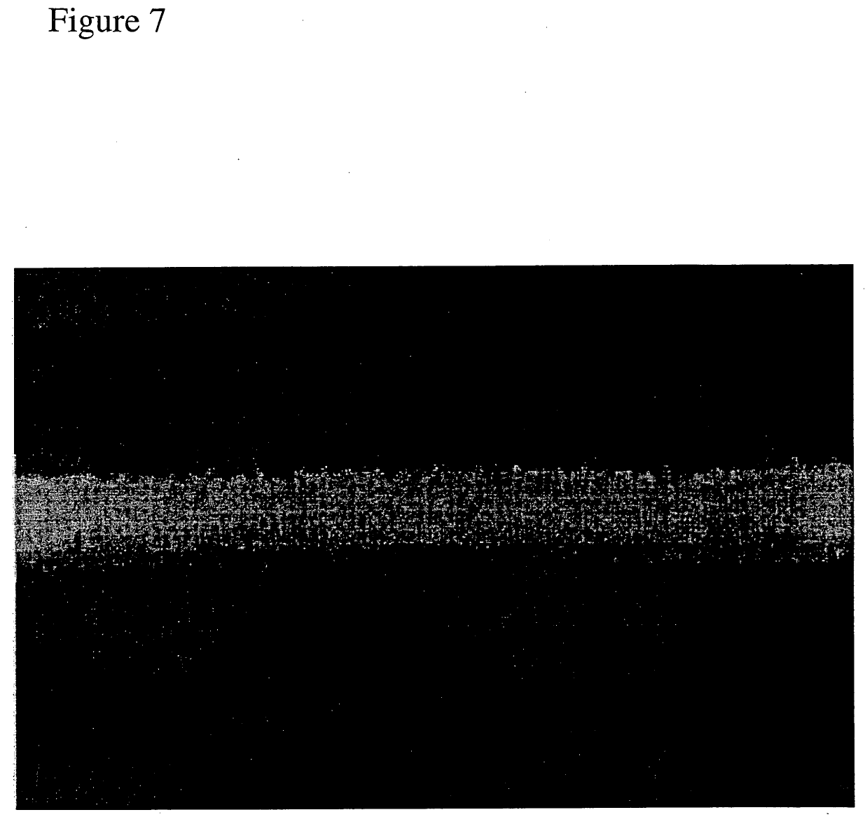

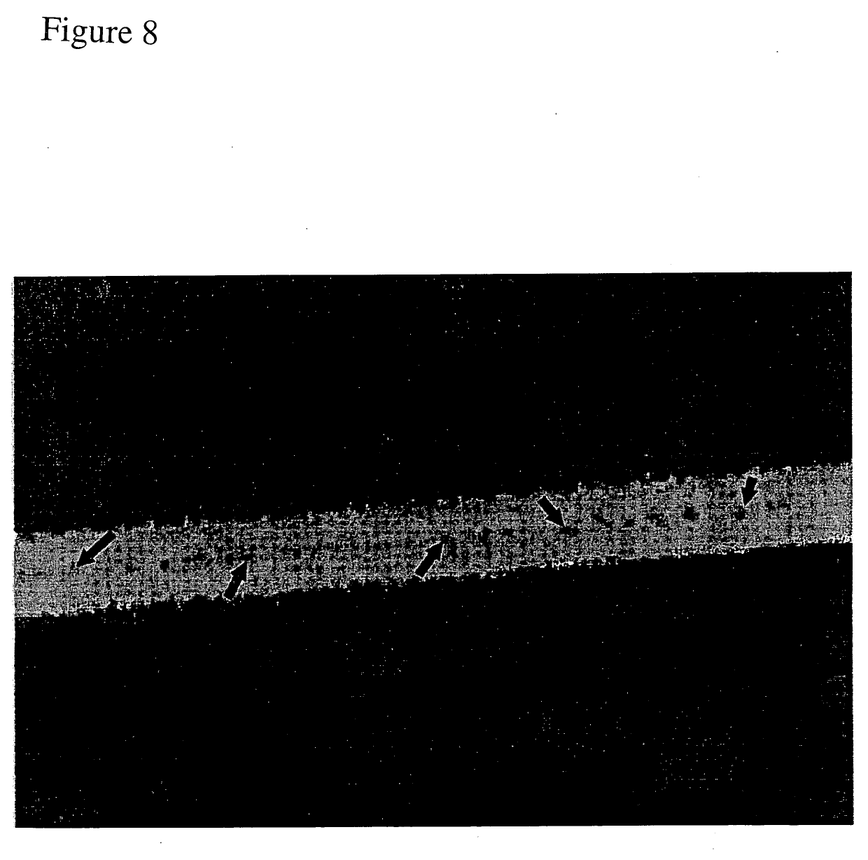

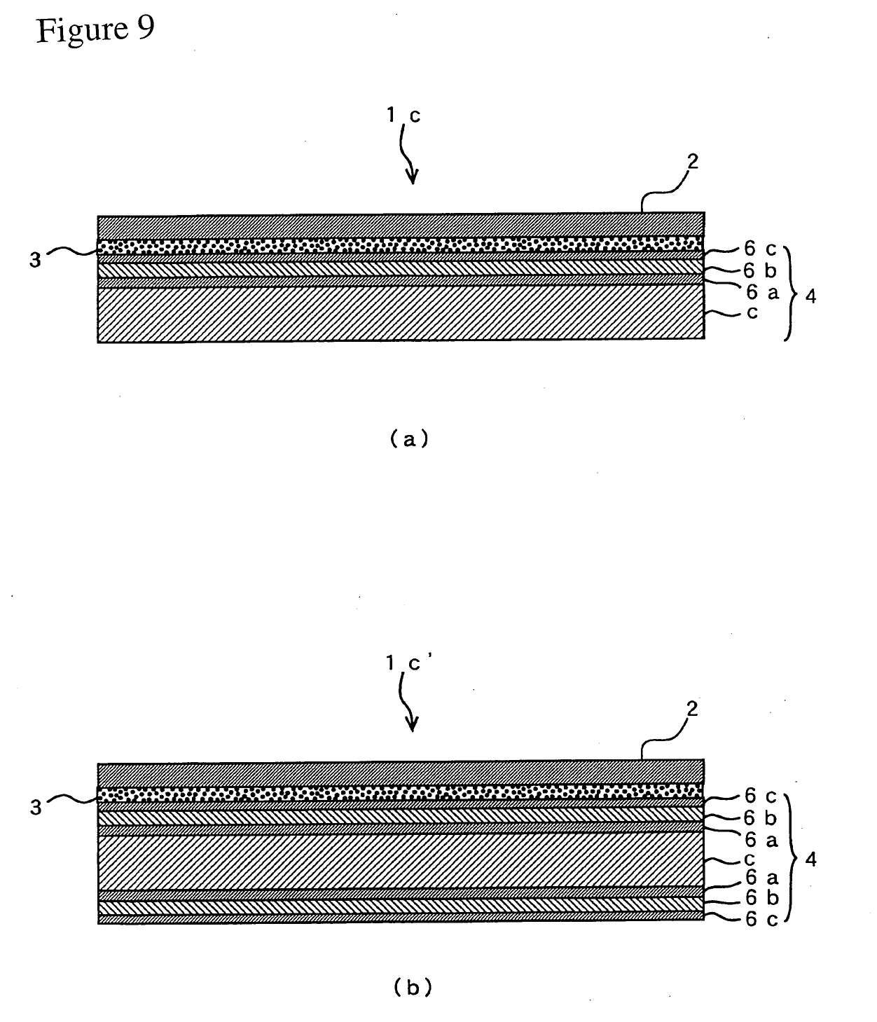

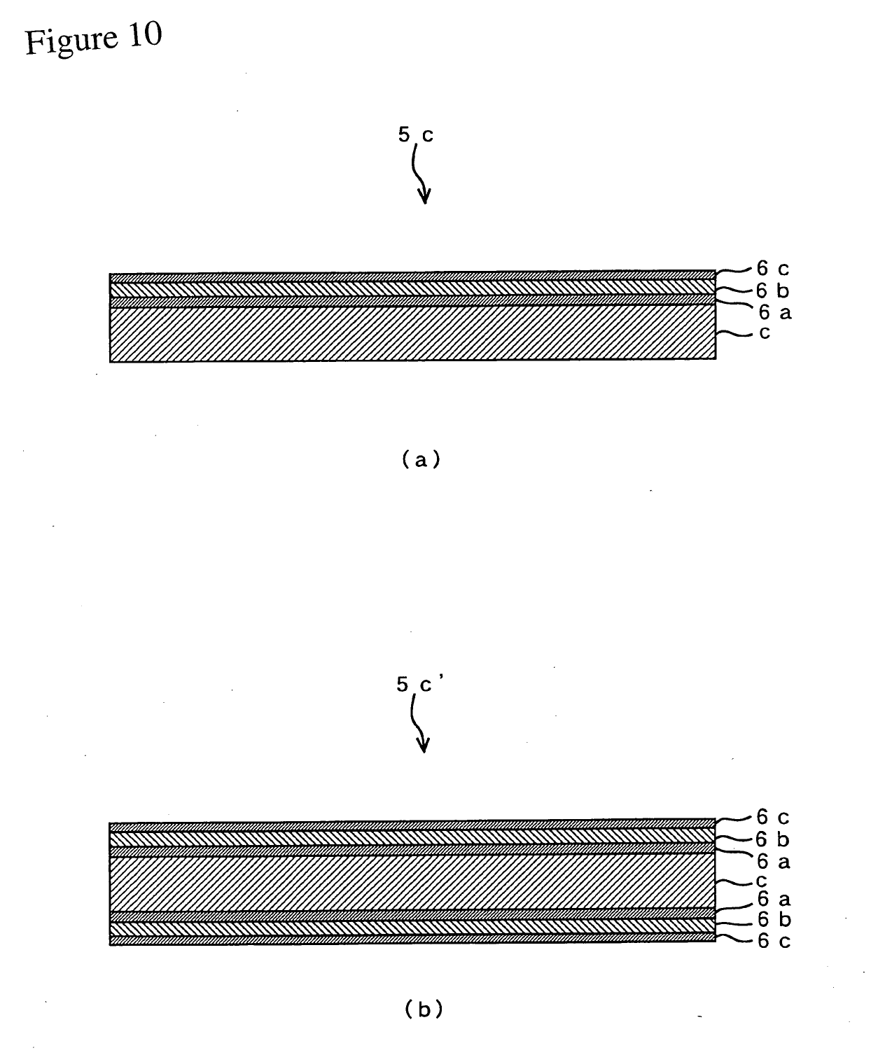

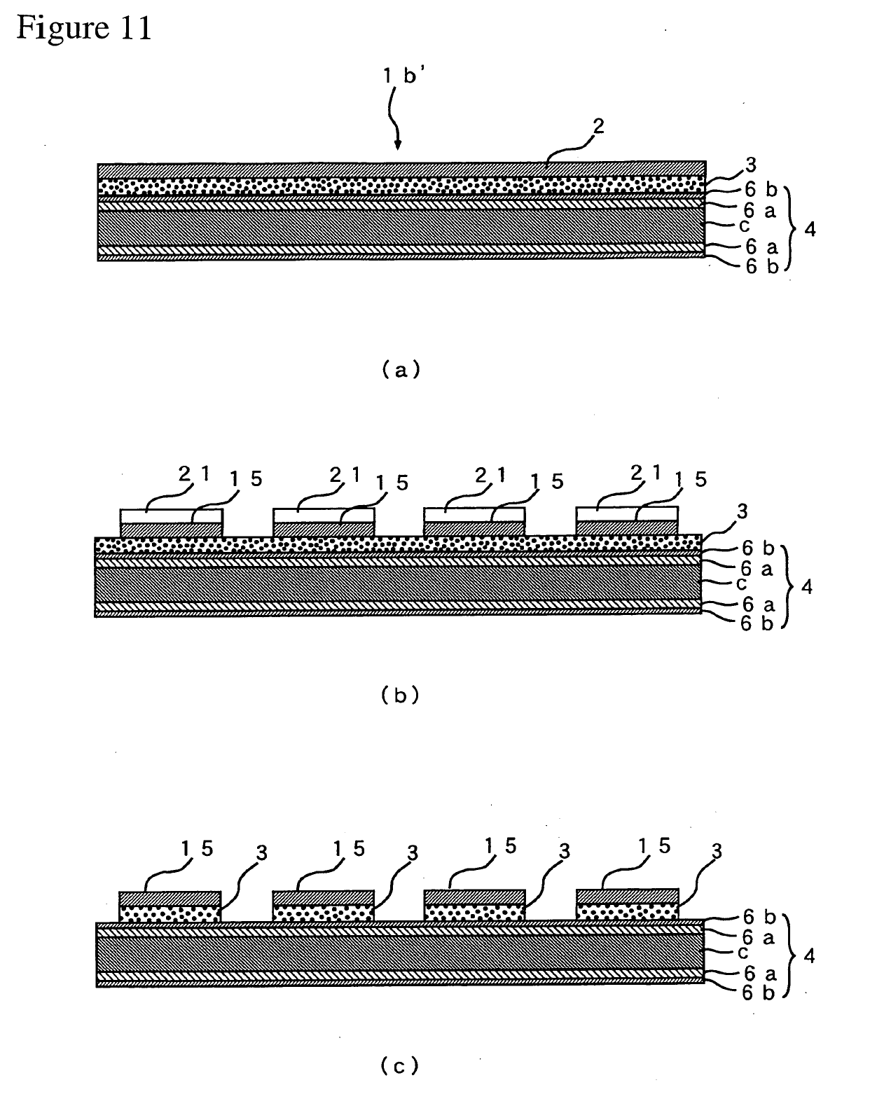

Production of the printed wiring board is described by referring to FIGS. 11 to 14. These figures schematically illustrate the capacitor layer forming material structures based on the layered structure 1b′ shown in FIG. 3(b). It is therefore stressed that the layered structure shall vary by material produced in Examples. Production of the printed wiring board is described below.

The etching resist layer 21 was formed on the first electroconductive layer 2 on one side of the capacitor layer forming material 1a thus produced, shown in FIG. 11(a), by conditioning the layer 2 surface and gluing a dry film to both sides of the layer. The etching resist layer on the first electroconductive layer was exposed to an etching pattern for forming the upper electrode and developed. It was then etched with an etching solution of copper chloride to form the upper electrode 15, shown in FIG. 11(b).

On formation of the upper electrode 15, the exposed dielectric layer was removed, except that in the circuit section on which the etching resist was kept remained, by wet blasting, where a grinding slurry with an abrasive of fine alumina particles (central particle size: 14 μm) dispersed in water (abrasive concentration: 14% by volume) was jetted at a high speed under a hydraulic pressure of 0.20 MPa through a slit nozzle (90 mm long and 2 mm wide) onto the surface to be ground, to remove the unnecessary dielectric layer. On completion of the wet blasting treatment, the etching resist was removed, and the treated capacitor layer forming material was washed with water and dried to give this state illustrated in FIG. 11(c).

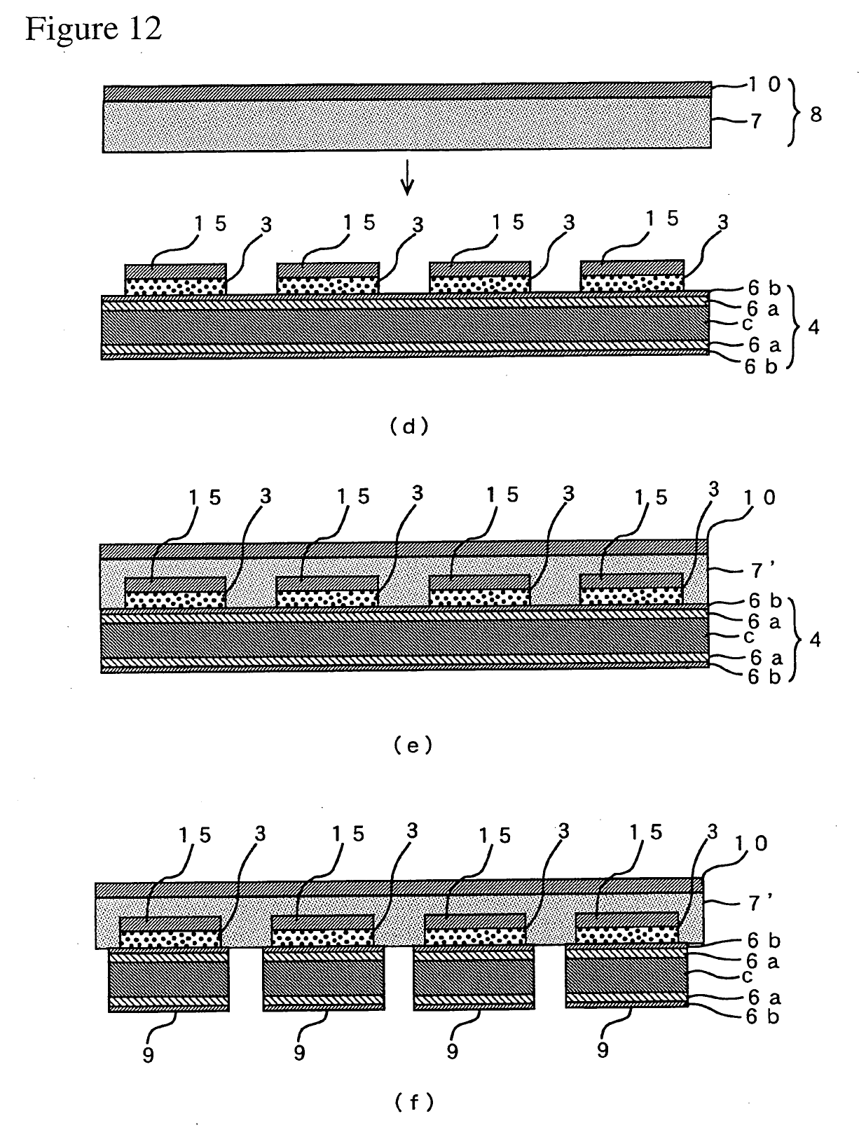

The capacitor layer forming material, treated to remove the unnecessary dielectric layer, should be treated to fill the gap, deepened as a result of removal of the exposed dielectric layer, between the upper electrodes. Therefore, the capacitor layer forming material was coated with an insulation and electroconductive layers on both sides, where the resin-coated copper foil 8 comprising the copper foil 10 coated with the 80 μm thick semi-cured resin layer 7 on one side was put on the capacitor layer forming material, as shown in FIG. 12(d), and hot-pressed at 180° C. for 60 minutes. This produced the capacitor layer forming material coated with the insulation layer 7′ and copper foil layer 10, as illustrated in FIG. 12(e). Then, the second electroconductive layer 4, shown in FIG. 12(e), as the outer layer was etched to form the lower electrode 9. This state is illustrated in FIG. 12(f).

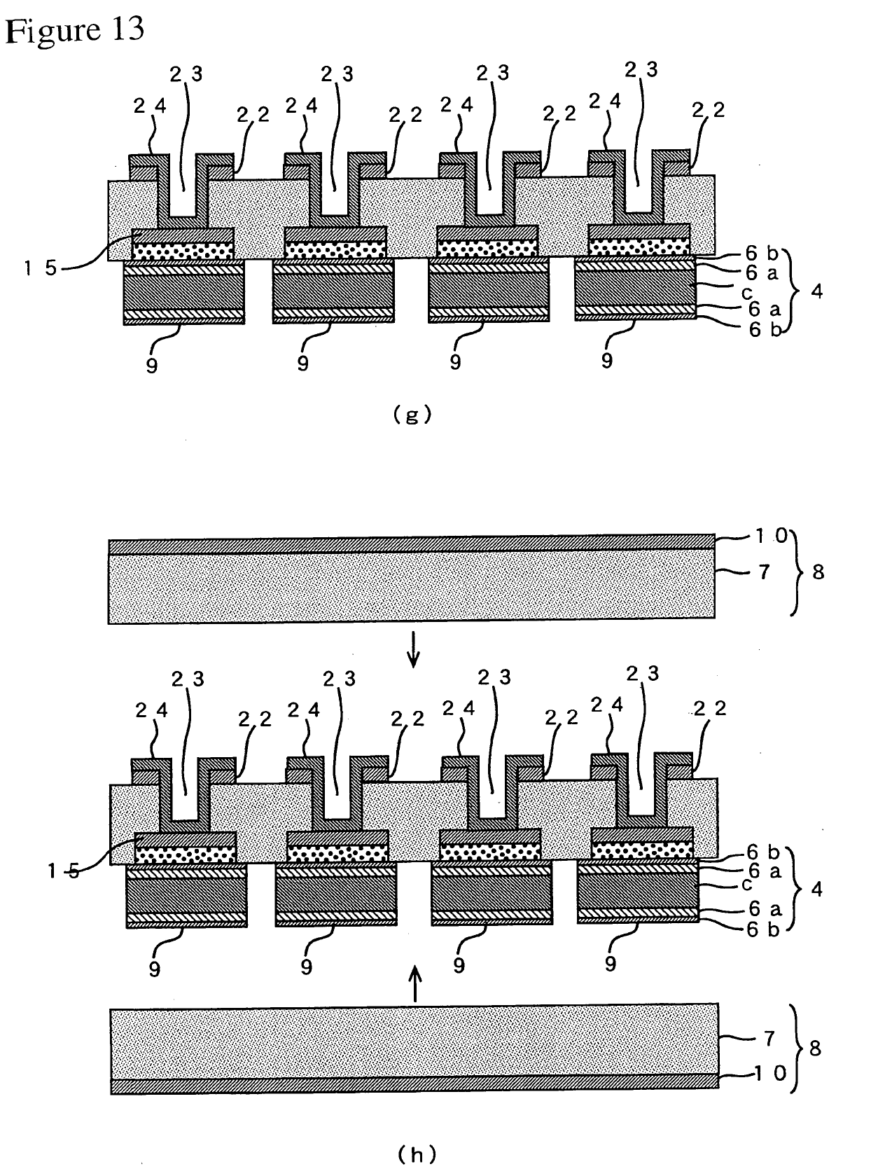

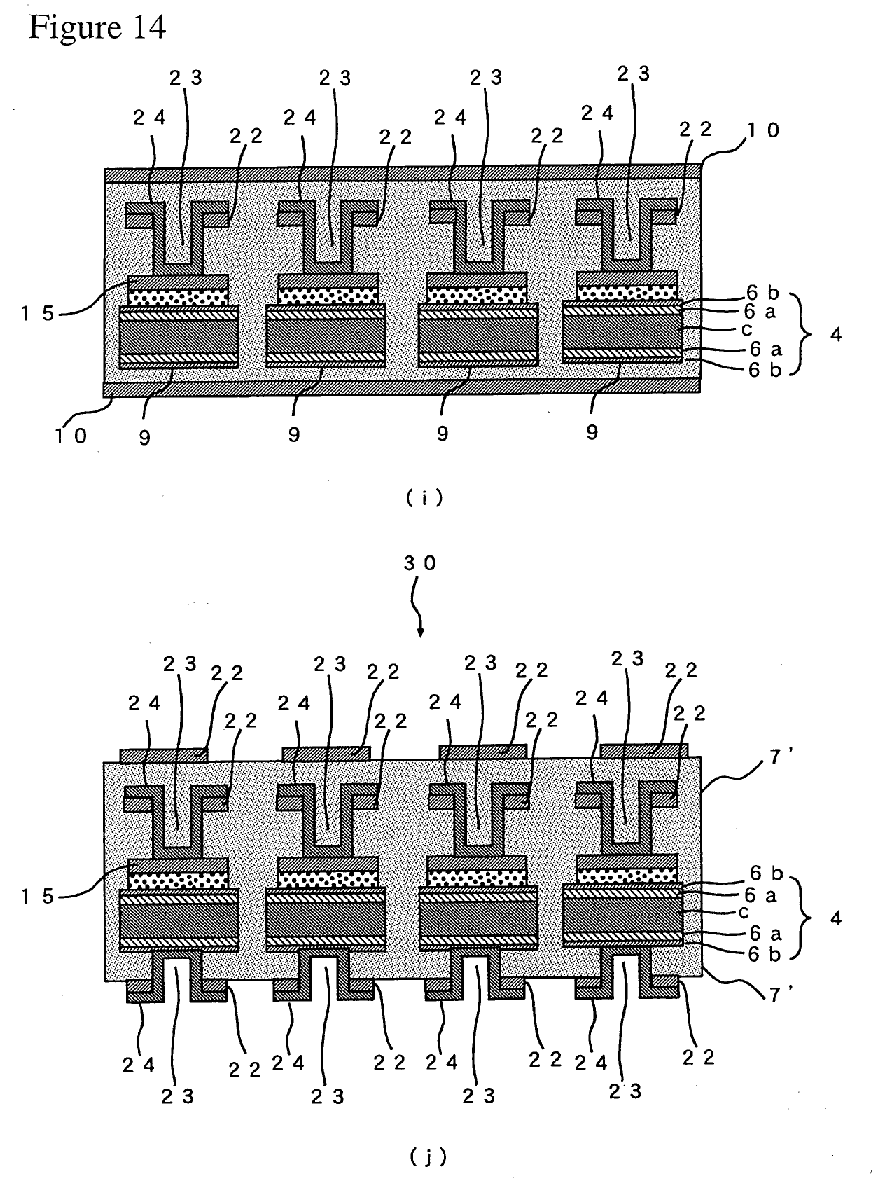

Next, the copper foil layer 10 as the outer layer of the capacitor layer forming material was coated with the plated copper layer 24 by a common procedure to form the outer circuits 22 and via holes 23 in the layer 10, and etched. This state is illustrated in FIG. 13(g). Then, the resin-coated copper foil 8 was put on the capacitor layer forming material, as illustrated in FIG. 13(h), and hot-pressed at 180° C. for 60 minutes, to form the copper foil layer 10 and insulation layer 7′ on the outer layer. This state is illustrated in FIG. 14(i).

Then, the copper foil layer 10 as the outer layer of the capacitor layer forming material, shown in FIG. 14(i), was coated with the plated copper layer 24 by a common procedure to form the outer circuits 22 and via holes 23 in the layer 10, and etched. This produced the printed wiring board 30 with the built-in capacitor circuit, as illustrated in FIG. 12(j).

### EXAMPLE 2

Example 2 produced the first composite foil provided with a cobalt layer, capacitor layer forming material using the first composite foil, and printed wiring board with a built-in capacitor circuit.

<Production of the First Composite Foil>

An electrolytic copper foil (thickness: 12 μm, VLP foil, Mitsui Mining & Smelting) was dipped in an electrolytic plating solution of cobalt of the following composition, and plated under the following conditions to form a plated cobalt layer on the foil, to a thickness of 2 μm on the glossy surface and to a thickness equivalent to 3 μm on the rough surface. The resulting first composite foil had a total thickness of 17.8 μm.

(Cobalt Plating Solution Composition)

| | | |
|---|---|---|
| CoSO₄.7H₂O | 180 | g/L |
| H₃BO₃ | 30 | g/L |
| Coagulant | 0.1 | g/L |

(Acrylamide-based polymer, PN-171 ®, Kurita Kogyo)

(Plating Conditions)

| | |
|---|---|
| Solution temperature | 35° C. |
| pH | 4 |
| Current density | 10 A/dm² |
| Stirring | Adopted |

The second composite foil produced above was analyzed for its tensile strength and elongation under the normal state and after it was treated at 400° C. for 10 hours under a vacuum, in the same manner as in Example 1. The results are given in Table 1.

The capacitor layer forming material and printed wiring board with a built-in capacitor circuit were produced in the same manner as in Example 1. A given voltage was applied to the capacitor layer forming material for observing interlayer voltage withstanding. No short-circuit phenomenon was observed between the first and second electroconductive layers. The printed wiring board with a built-in capacitor circuit could be produced without any difficulty.

### EXAMPLE 3

Example 3 produced the first composite foil provided with a nickel/cobalt alloy layer, capacitor layer forming material using the first composite foil, and printed wiring board with a built-in capacitor circuit.

<Production of the First Composite Foil>

An electrolytic copper foil (thickness: 12 μm, VLP foil, Mitsui Mining & Smelting) was dipped in an electrolytic plating solution of nickel/cobalt alloy of the following composition, and plated under the following conditions to form a plated nickel/cobalt alloy layer on the foil, to a thickness of 2 μm on the glossy surface and to a thickness equivalent to 3 μm on the rough surface. The resulting first composite foil had a total thickness of 17.2 μm.

(Nickel/Cobalt Electrolytic Plating Solution Composition)

| | |
|---|---|
| NiSO₄.6H₂O | 200 g/L |
| NiCl₂.6H₂O | 36 g/L |
| CoSO₄.7H₂O | 12 g/L |
| H₃BO₃ | 30 g/L |
| HCOONa | 45 g/L |

(Plating Conditions)

| | |
|---|---|
| Solution temperature | 45° C. |
| pH | 4 |
| Current density | 10 A/dm² |
| Stirring | Adopted |

The third composite foil produced above was analyzed for its tensile strength and elongation under the normal state and after it was treated at 400° C. for 10 hours under a vacuum, in the same manner as in Example 1. The results are given in Table 1.

The capacitor layer forming material and printed wiring board with a built-in capacitor circuit were produced in the same manner as in Example 1. A voltage was applied to the capacitor layer forming material, however, no short-circuit phenomenon was observed between the first and second electroconductive layers. The printed wiring board with a built-in capacitor circuit could thus be produced without any difficulty.

### EXAMPLE 4

Example 4 produced the second composite foil provided with a plated cobalt and plated hard nickel layers in this order using an electrolytic copper foil, capacitor layer forming material using the second composite foil, and printed wiring board with a built-in capacitor circuit.

<Production of the Second Composite Foil>

An electrolytic copper foil (thickness: 12 μm, VLP foil, Mitsui Mining & Smelting) was dipped in the same electrolytic plating solution of cobalt as that used in Example 2 and plated in the same manner as in Example 2 to form a plated cobalt layer on the foil to a thickness of 0.3 μm on the glossy surface and to a thickness equivalent to 0.3 μm on the rough surface; and then dipped in the same electrolytic plating solution of hard nickel as used in Example 1 and plated in the same manner as in Example 1 to form a plated hard nickel layer on the plated cobalt layer to a thickness of 2 μm on the glossy surface and to a thickness equivalent to 3 μm on the rough surface. The resulting second composite foil had a total thickness of 16.9 μm.

The second composite foil produced above was analyzed for its tensile strength and elongation under the normal state and after it was treated at 400° C. for 10 hours under a vacuum, in the same manner as in Example 1. The results are given in Table 1.

The capacitor layer forming material and printed wiring board with a built-in capacitor circuit were produced in the same manner as in Example 1. A voltage was applied to the capacitor layer forming material, however, no short-circuit phenomenon was observed between the first and second electroconductive layers. The printed wiring board with a built-in capacitor circuit could be produced without any difficulty.

### EXAMPLE 5

Example 5 produced the second composite foil provided with a plated iron and plated hard nickel layers in this order using an electrolytic copper foil, capacitor layer forming material using the second composite foil, and printed wiring board with a built-in capacitor circuit.

<Production of the Second Composite Foil>

An electrolytic copper foil (thickness: 12 μm, VLP foil, Mitsui Mining & Smelting) was dipped in an electrolytic plating solution of iron sulfate of the following composition, and plated under the following conditions to form a plated iron layer on the foil to a thickness of 0.3 μm on the glossy surface and to a thickness equivalent to 0.3 μm on the rough surface; and then dipped in the same electrolytic plating solution of hard nickel as used in Example 1 and plated in the same manner as in Example 1 to form a plated hard nickel layer on the plated cobalt layer to a thickness of 2 μm on the glossy surface and to a thickness equivalent to 3 μm on the rough surface. The resulting second composite foil had a total thickness of 17.4 μm.

(Iron Sulfate Plating Solution Composition)

| | |
|---|---|
| FeSO₄.7H₂O | 180 g/L |
| H₃BO₃ | 30 g/L |

(Plating Conditions)

| | |
|---|---|
| Solution temperature | 30° C. |
| pH | 4 |
| Current density | 5 A/dm² |
| Stirring | Adopted |

The second composite foil produced above was analyzed for its tensile strength and elongation under the normal state and after it was treated at 400° C. for 10 hours under a vacuum, in the same manner as in Example 1. The results are given in Table 1.

The capacitor layer forming material and printed wiring board with a built-in capacitor circuit were produced in the same manner as in Example 1. A voltage was applied to the capacitor layer forming material, however, no short-circuit phenomenon was observed between the first and second electroconductive layers. The printed wiring board with a built-in capacitor circuit could thus be produced without any difficulty.

### EXAMPLE 6

Example 6 produced the third composite foil provided with a plated cobalt (first cobalt layer), plated hard nickel and plated cobalt (second cobalt layer) layers in this order on a copper foil surface, capacitor layer forming material using the third composite foil, and printed wiring board with a built-in capacitor circuit.

<Production of the Third Composite Foil>

An electrolytic copper foil (thickness: 12 μm, VLP foil, Mitsui Mining & Smelting) was dipped in the same electrolytic plating solution of cobalt sulfate as that used in Example 2 and plated in the same manner as in Example 2 to form a plated first cobalt layer on the foil on both sides to a thickness of 0.3 μm on the glossy surface and to a thickness equivalent to 0.3 μm on the rough surface; then dipped in the same electrolytic plating solution of hard nickel as that used in Example 1 and plated in the same manner as in Example 1 to form a plated hard nickel layer on the plated cobalt layer on both sides to a thickness of 3 μm on the glossy surface and to a thickness equivalent to 3 μm on the rough surface; and dipped in the same electrolytic plating solution of cobalt sulfate as that used in Example 2 and plated in the same manner as in Example 2 to form a plated second cobalt layer to a thickness of 0.3 μm on the glossy surface and to a thickness equivalent to 0.3 μm on the rough surface. The resulting third composite foil had a total thickness of 19.2 μm.

The third composite foil produced above was analyzed for its tensile strength and elongation under the normal state and after it was treated at 400° C. for 10 hours under a vacuum, in the same manner as in Example 1. The results are given in Table 1.

The capacitor layer forming material and printed wiring board with a built-in capacitor circuit were produced in the same manner as in Example 1. A voltage was applied to the capacitor layer forming material, however, no short-circuit phenomenon was observed between the first and second electroconductive layers. The printed wiring board with a built-in capacitor circuit could thus be produced without any difficulty.

### EXAMPLE 7

Example 7 produced the third composite foil provided with a plated iron, plated hard nickel and plated cobalt layers in this order on a copper foil surface, capacitor layer forming material using the third composite foil, and printed wiring board with a built-in capacitor circuit.

A copper foil (thickness: 12 μm, VLP foil, Mitsui Mining & Smelting) was dipped in the same electrolytic plating solution of iron sulfate as that used in Example 5 and plated in the same manner as in Example 5 to form a plated iron layer on the foil on both sides to a thickness of 0.3 μm on the glossy surface and to a thickness equivalent to 0.3 μm on the rough surface; then dipped in the same electrolytic plating solution of hard nickel as that used in Example 1 and plated in the same manner as in Example 1 to form a plated hard nickel layer on the plated cobalt layer on both sides to a thickness of 3 μm on the glossy surface and to a thickness equivalent to 3 μm on the rough surface; and dipped in the same electrolytic plating solution of cobalt sulfate as that used in Example 2 and plated in the same manner as in Example 2 to form a plated second cobalt layer to a thickness of 0.3 μm on the glossy surface and to a thickness equivalent to 0.3 μm on the rough surface. The resulting third composite foil had a total thickness of 19.3 μm.

The third composite foil produced above was analyzed for its tensile strength and elongation under the normal state and after it was treated at 400° C. for 10 hours under a vacuum, in the same manner as in Example 1. The results are given in Table 1.

The capacitor layer forming material and printed wiring board with a built-in capacitor circuit were produced in the same manner as in Example 1. A voltage was applied to the capacitor layer forming material, however, no short-circuit phenomenon was observed between the first and second electroconductive layers. The printed wiring board with a built-in capacitor circuit could thus be produced without any difficulty.

### COMPARATIVE EXAMPLE 1

Comparative Example 1 attempted to produce a capacitor layer forming material using an electrolytic copper foil in Example 1 (thickness: 12 μm, VLP foil, Mitsui Mining & Smelting) free of plated hard nickel layer and printed wiring board with a built-in capacitor circuit.

However, the procedure similar to that used in Example 1 for producing a capacitor layer forming material failed to form a dielectric layer on the foil by the sol-gel method, because the foil surface was notably oxidized following thermal discomposition at 500° C. for 15 minutes in the atmosphere. Moreover, oxidation on the electrolytic copper foil surface was enhanced when the coating procedure was repeated 6 times to adjust layer thickness. The foil was embrittled due to oxidation when finally fired at 600° C. for 30 minutes in a nitrogen substituted atmosphere, and could be easily cracked. Therefore, Comparative Example 1 failed to produce a capacitor layer forming material and printed wiring board, because all of the steps thereafter could not be implemented.

### COMPARATIVE EXAMPLE 2

Comparative Example 2 produced a composite copper foil for the second electroconductive layer in the same manner as in Example 1, except that the plated hard nickel layer was replaced by a plated nickel/phosphorus alloy layer. In the following description, duplication is minimized as far as possible.

An electrolytic copper foil (thickness: 12 μm, VLP foil, Mitsui Mining & Smelting) was dipped in an electrolytic plating solution of nickel/phosphorus alloy of the following composition, and plated under the following conditions to form a plated nickel/phosphorus alloy layer (nickel content: 0.3% by weight) on the foil, to a thickness of 2 μm on the glossy surface and to a thickness equivalent to 3 μm on the rough surface, to produce the 15 μm thick first composite foil.

The nickel/phosphorus alloy layer was electrolytically deposited uniformly and smoothly on both sides of the foil by a phosphoric-acid-basedplating solution comprising nickel sulfate (250 g/L), nickel chloride (40.39 g/L), H₃BO₃ (19.78 g/L) and H₃PO₃ (3 g/L) under the conditions of solution temperature: 50° C. and current density: 20 A/dm².

The composite foil was provided with a dielectric layer by a sol-gel method, and with a first and second electroconductive layers on both sides of the dielectric layer in the same manner as in Example 1, to produce the capacitor layer forming material. An interlayer voltage withstanding test, conducted at this stage, showed a short-circuit phenomenon occurring between the first and second electroconductive layers. As a result, the product yield was limited to 60%.

TABLE 1

| | Normal state | | After heat treatment *1 | |
|---|---|---|---|---|
| | Tensile | | Tensile | |
| Ex./ | strength | Elongation | strength | Elongation |
| Com. Ex. | (kgf/mm²) | (%) | (kgf/mm²) | (%) |
| Ex. 1 | 81.5 | 3.9 | 57.4 | 5.3 |
| Ex. 2 | 82.8 | 3.2 | 63.4 | 2.2 |
| Ex. 3 | 76.8 | 5.7 | 62.5 | 4.4 |
| Ex. 4 | 81.9 | 2.9 | 60.3 | 1.3 |
| Ex. 5 | 92.7 | 2.6 | 62.8 | 2.5 |
| Ex. 6 | 83.6 | 3.1 | 62.5 | 2.8 |
| Ex. 7 | 93.5 | 2.8 | 62.7 | 3.2 |
| Com. Ex. 1 | 52.0 | 6.1 | 31.3 | 15.6 |
| Com. Ex. 2 | 72.0 | 3.2 | 37.0 | 3.1 |

*1: The heat treatment was carried out at 400° C. for 10 hours under a vacuum.

The capacitor layer forming material of the present invention is provided with the above-described highly heat-resistant composite foil for the second electroconductive layer which constitutes the lower electrode. Therefore, it is suitable for producing a multilayer printed wiring board with a substrate of Teflon or liquid-crystal polymer. The capacitor circuit of the above material will have no abnormality in the lower electrode shape and will withstand expansion/contraction induced by heat from the surrounding materials, even when exposed cyclically to hot pressing carried out at 300 to 400° C., used for production of a multilayer printed wiring board with a substrate of Teflon or liquid-crystal polymer. The high heat resistance allows the composite foil to be coated with a dielectric layer without any difficulty by a sol-gel method, which involves severe heat treatment conditions.

Moreover, by selecting the type and structure of a layer composed of one or more dissimilar metal layers for the composite foil, which is used for the second electroconductive layer in the capacitor layer forming material, in accordance with a dielectric layer type, the dielectric layer and lower electrode remain highly adhesive to each other. The capacitor layer forming material of the present invention can be also used for a resistor circuit, because one or more of the dissimilar metal layers of the composite foil are high-resistance metals, e.g., nickel.

Finally, by adopting preferable plating conditions for the one or more dissimilar metal layers to be deposited on the foil, the method for producing the composite foil of the present invention can be performed at low cost.

What is claimed is:

1. A capacitor layer forming material comprising a first electroconductive layer used for forming an upper electrode and second electroconductive layer used for forming a lower electrode with a dielectric layer in-between for a printed wiring board, wherein
the second electroconductive layer is made of a composite foil comprising a copper layer coated with a plated hard nickel layer as a dissimilar metal layer.

2. The capacitor layer forming material according to claim 1, wherein the plated hard nickel layer is 0.5 to 3.0 μm thick.

3. A capacitor layer forming material comprising a first electroconductive layer used for forming an upper electrode and second electroconductive layer used for forming a lower electrode with a dielectric layer in-between for a printed wiring board, wherein
the second electroconductive layer is made of a composite foil comprising a copper layer coated with a plated cobalt layer as a dissimilar metal layer.

4. The capacitor layer forming material according to claim 3, wherein the plated cobalt layer is 0.5 to 3.0 μm thick.

5. A capacitor layer forming material comprising a first electroconductive layer used for forming an upper electrode and second electroconductive layer used for forming a lower electrode with a dielectric layer in-between for a printed wiring board, wherein
the second electroconductive layer is made of a composite foil comprising a copper layer coated with a plated nickel/cobalt alloy layer as a dissimilar metal layer.

6. The capacitor layer forming material according to claim 5, wherein the plated nickel/cobalt alloy layer is 0.5 to 3.0 μm thick.

7. A capacitor layer forming material comprising a first electroconductive layer used for forming an upper electrode and second electroconductive layer used for forming a lower electrode with a dielectric layer in-between for a printed wiring board, wherein
the second electroconductive layer is made of a composite foil comprising a copper layer coated with 2 dissimilar metal layers of plated cobalt and plated hard nickel in this order.

8. The capacitor layer forming material according to claim 7, wherein the plated cobalt layer is 0.1 to 0.5 μm thick and the plated hard nickel layer is 0.3 to 2.0 μm thick.

9. A capacitor layer forming material comprising a first electroconductive layer used for forming an upper electrode and second electroconductive layer used for forming a lower electrode with a dielectric layer in-between for a printed wiring board, wherein
the second electroconductive layer is made of a composite foil comprising a copper layer coated with 2 dissimilar metal layers of plated iron and plated hard nickel in this order.

10. The capacitor layer forming material according to claim 9, wherein the plated iron layer is 0.1 to 0.5 μm thick and the plated hard nickel layer is 0.3 to 2.0 μm thick.

11. A capacitor layer forming material comprising a first electroconductive layer used for forming an upper electrode and second electroconductive layer used for forming a lower electrode with a dielectric layer in-between for a printed wiring board, wherein
the second electroconductive layer is made of a composite foil comprising a copper layer coated with 3 dissimilar metal layers of plated cobalt (first cobalt layer), plated hard nickel and plated cobalt (second cobalt layer) in this order.

12. The capacitor layer forming material according to claim 11, wherein the plated first cobalt layer is 0.1 to 0.5 μm thick, the plated hard nickel layer is 0.3 to 2.0 μm thick and the plated second cobalt layer is 0.1 to 0.5 μm thick.

13. A capacitor layer forming material comprising a first electroconductive layer used for forming an upper electrode and second electroconductive layer used for forming a lower electrode with a dielectric layer in-between for a printed wiring board, wherein
the second electroconductive layer is made of a composite foil comprising a copper layer coated with 3 dissimilar metal layers of plated iron, plated hard nickel and plated cobalt in this order.

14. The capacitor layer forming material according to claim 13, wherein the plated iron layer is 0.1 to 0.5 μm thick, the plated hard nickel layer is 0.3 to 2.0 μm thick and the plated cobalt layer is 0.1 to 0.5 μm thick.

15. The capacitor layer forming material according to claim 1, wherein the copper layer is of an electrolytic or rolled copper foil having a nominal thickness of 9 to 35 μm.

16. The capacitor layer forming material according to claim 2, wherein the copper layer is of an electrolytic or rolled copper foil having a nominal thickness of 9 to 35 μm.

17. The capacitor layer forming material according to claim 3, wherein the copper layer is of an electrolytic or rolled copper foil having a nominal thickness of 9 to 35 μm.

18. The capacitor layer forming material according to claim 4, wherein the copper layer is of an electrolytic or rolled copper foil having a nominal thickness of 9 to 35 μm.

19. The capacitor layer forming material according to claim 5, wherein the copper layer is of an electrolytic or rolled copper foil having a nominal thickness of 9 to 35 μm.

20. The capacitor layer forming material according to claim 6, wherein the copper layer is of an electrolytic or rolled copper foil having a nominal thickness of 9 to 35 μm.

21. The capacitor layer forming material according to claim 7, wherein the copper layer is of an electrolytic or rolled copper foil having a nominal thickness of 9 to 35 μm.

22. The capacitor layer forming material according to claim 8, wherein the copper layer is of an electrolytic or rolled copper foil having a nominal thickness of 9 to 35 μm.

23. The capacitor layer forming material according to claim 9, wherein the copper layer is of an electrolytic or rolled copper foil having a nominal thickness of 9 to 35 μm.

24. The capacitor layer forming material according to claim 10, wherein the copper layer is of an electrolytic or rolled copper foil having a nominal thickness of 9 to 35 μm.

25. The capacitor layer forming material according to claim 11, wherein the copper layer is of an electrolytic or rolled copper foil having a nominal thickness of 9 to 35 μm.

26. The capacitor layer forming material according to claim 12, wherein the copper layer is of an electrolytic or rolled copper foil having a nominal thickness of 9 to 35 μm.

27. The capacitor layer forming material according to claim 13, wherein the copper layer is of an electrolytic or rolled copper foil having a nominal thickness of 9 to 35 μm.

28. The capacitor layer forming material according to claim 14, wherein the copper layer is of an electrolytic or rolled copper foil having a nominal thickness of 9 to 35 μm.

29. A method for producing a composite foil to be used for the second electroconductive layer in the capacitor layer forming material of the present invention, the composite foil comprising a copper layer coated with a plated hard nickel layer as a dissimilar metal layer, wherein
the copper foil is dipped in an electrolytic plating solution of hard nickel of the following composition, and electrolytically plated under the following conditions to form a plated hard nickel layer:

| | |
|---|---|
| NiSO₄.6H₂O | 100 to 180 g/L |
| NH₄Cl concentration | 20 to 30 g/L |
| H₃BO₃ concentration | 20 to 60 g/L |
| Solution temperature | 20 to 50° C. |
| pH | 3 to 5 |
| Current density | 1 to 50 A/dm² |
| Stirring | Adopted |

30. A method for producing a composite foil to be used for the second electroconductive layer in the capacitor layer forming material of the present invention, the composite foil comprising a copper layer coated with a plated cobalt layer as a dissimilar metal layer, wherein
the copper foil is dipped in an electrolytic plating solution of cobalt sulfate of the following composition, and electrolytically plated under the following conditions to form a plated cobalt layer:

| | |
|---|---|
| CoSO₄.7H₂O | 120 to 200 g/L |
| H₃BO₃ | 25 to 50 g/L |
| Solution temperature | 20 to 50° C. |
| pH | 2 to 5 |
| Current density | 1 to 50 A/dm² |
| Stirring | Adopted |

31. The method for producing a composite foil according to claim 30, wherein the electrolytic plating solution of cobalt sulfate is incorporated with a coagulant at a concentration of 0.05 to 0.3 g/L.

32. A method for producing a composite foil to be used for the second electroconductive layer in the capacitor layer forming material of the present invention, the composite foil comprising a copper layer coated with a plated nickel/cobalt alloy layer as a dissimilar metal layer, wherein
the copper foil is dipped in an electrolytic plating solution of nickel/cobalt alloy of the following composition, and electrolytically plated under the following conditions to form a plated nickel/cobalt alloy layer:

| | |
|---|---|
| NiSO₄.6H₂O | 100 to 200 g/L |
| NiCl₂.6H₂O | 30 to 50 g/L |
| CoSO₄.7H₂O | 10 to 30 g/L |
| H₃BO₃ | 20 to 40 g/L |
| Solution temperature | 20 to 50° C. |
| pH | 2 to 5 |
| Current density | 1 to 25 A/dm² |
| Stirring | Adopted |

33. A method for producing a composite foil to be used for the second electroconductive layer in the capacitor layer forming material of the present invention, the composite foil comprising a copper layer coated with plated cobalt and plated hard nickel layers as dissimilar metal layers, wherein
the copper foil is dipped in an electrolytic plating solution of cobalt sulfate of the following composition A, and electrolytically plated under the following conditions A to form a plated cobalt layer, and then dipped in an electrolytic plating solution of hard nickel of the following composition B, and electrolytically plated under the following conditions B to form a plated hard nickel layer:
[Solution composition and electrolysis conditions A]

| | |
|---|---|
| CoSO₄.7H₂O | 120 to 200 g/L |
| H₃BO₃ | 25 to 50 g/L |
| Solution temperature | 20 to 50° C. |
| pH | 2 to 5 |
| Current density | 1 to 50 A/dm² |
| Stirring | Adopted |

[Solution composition and electrolysis conditions B]

| | |
|---|---|
| NiSO₄.6H₂O | 100 to 180 g/L |
| NH₄Cl concentration | 20 to 30 g/L |
| H₃BO₃ concentration | 20 to 60 g/L |
| Solution temperature | 20 to 50° C. |
| pH | 4 to 5 |
| Current density | 1 to 50 A/dm² |
| Stirring | Adopted |

34. The method for producing a composite foil according to claim 33, wherein the electrolytic plating solution of cobalt sulfate is incorporated with a coagulant at a concentration of 0.05 to 0.3 g/L.

35. A method for producing a composite foil to be used for the second electroconductive layer in the capacitor layer forming material of the present invention, the composite foil comprising a copper layer coated with plated iron and plated hard nickel layers as dissimilar metal layers, wherein
the copper foil is dipped in an electrolytic plating solution of iron sulfate of the following composition A, and electrolytically plated under the following conditions A to form a plated iron layer, and then dipped in an electrolytic plating solution of hard nickel of the following composition B, and electrolytically plated under the following conditions B to form a plated hard nickel layer:
[Solution composition and electrolysis conditions A]

| | |
|---|---|
| FeSO₄.7H₂O | 100 to 200 g/L |
| H₃BO₃ | 25 to 50 g/L |
| Solution temperature | 20 to 50° C. |
| pH | 2 to 5 |
| Current density | 1 to 30 A/dm² |
| Stirring | Adopted |

[Solution composition and electrolysis conditions B]

| | |
|---|---|
| NiSO₄.6H₂O | 100 to 180 g/L |
| NH₄Cl concentration | 20 to 30 g/L |
| H₃BO₃ concentration | 20 to 60 g/L |
| Solution temperature | 20 to 50° C. |
| pH | 4 to 5 |
| Current density | 1 to 50 A/dm² |
| Stirring | Adopted |

36. The method for producing a composite foil according to claim 35, wherein the electrolytic plating solution of iron sulfate is incorporated with a coagulant at a concentration of 0.05 to 0.3 g/L.

37. A method for producing a composite foil to be used for the second electroconductive layer in the capacitor layer forming material of the present invention, the composite foil comprising a copper layer coated with plated cobalt (first cobalt layer), plated hard nickel and plated cobalt (second cobalt layer) layers as dissimilar metal layers, wherein
the copper foil is dipped in an electrolytic plating solution of cobalt sulfate of the following composition A, and electrolytically plated under the following conditions A to form a plated first cobalt layer; then dipped in an electrolytic plating solution of hard nickel of the following composition B, and electrolytically plated under the following conditions to form a plated hard nickel layer; and dipped in an electrolytic plating solution of cobalt sulfate of the following composition A, and electrolytically plated under the following conditions A to form a plated second cobalt layer:
[Solution composition and electrolysis conditions A]

| | |
|---|---|
| CoSO₄.7H₂O | 120 to 200 g/L |
| H₃BO₃ | 25 to 50 g/L |
| Solution temperature | 20 to 50° C. |
| pH | 2 to 5 |
| Current density | 1 to 50 A/dm² |
| Stirring | Adopted |

[Solution composition and electrolysis conditions B]

| | |
|---|---|
| NiSO₄.6H₂O | 100 to 180 g/L |
| NH₄Cl concentration | 20 to 30 g/L |
| H₃BO₃ concentration | 20 to 60 g/L |
| Solution temperature | 20 to 50° C. |
| pH | 4 to 5 |
| Current density | 1 to 50 A/dm² |
| Stirring | Adopted |

38. The method for producing a composite foil according to claim 37, wherein the electrolytic plating solution of cobalt sulfate is incorporated with a coagulant at a concentration of 0.05 to 0.3 g/L.

39. A method for producing a composite foil to be used for the second electroconductive layer in the capacitor layer forming material of the present invention, the composite foil comprising a copper layer coated with plated iron, plated hard nickel and plated cobalt layers as dissimilar metal layers, wherein
the copper foil is dipped in an electrolytic plating solution of iron sulfate of the following composition A, and electrolytically plated under the following conditions A to form a plated iron layer; then dipped in an electrolytic plating solution of hard nickel of the following composition B, and electrolytically plated under the following conditions B to form a plated hard nickel layer; and dipped in an electrolytic plating solution of cobalt sulfate of the following composition C, and electrolytically plated under the following conditions C to form a plated cobalt layer:
[Solution composition and electrolysis conditions A]

| | |
|---|---|
| FeSO₄.7H₂O | 100 to 200 g/L |
| H₃BO₃ | 20 to 50 g/L |
| Solution temperature | 20 to 50° C. |
| pH | 2 to 5 |
| Current density | 1 to 30 A/dm² |
| Stirring | Adopted |

[Solution composition and electrolysis conditions B]

| | |
|---|---|
| NiSO₄.6H₂O | 100 to 180 g/L |
| NH₄Cl concentration | 20 to 30 g/L |
| H₃BO₃ concentration | 20 to 60 g/L |
| Solution temperature | 20 to 50° C. |
| pH | 4 to 5 |
| Current density | 1 to 50 A/dm² |
| Stirring | Adopted |

[Solution composition and electrolysis conditions C]

| | |
|---|---|
| CoSO₄.7H₂O | 120 to 200 g/L |
| H₃BO₃ | 20 to 50 g/L |
| Solution temperature | 20 to 50° C. |
| pH | 2 to 5 |
| Current density | 1 to 50 A/dm² |
| Stirring | Adopted |

40. The method for producing a composite foil according to claim 39, wherein the electrolytic plating solution of cobalt sulfate is incorporated with a coagulant at a concentration of 0.05 to 0.3 g/L.

41. A printed wiring board with a built-in capacitor circuit which uses a capacitor layer forming material comprising a first electroconductive layer used for forming an upper electrode and second electroconductive layer used for forming a lower electrode with a dielectric layer in-between, wherein
the second electroconductive layer is made of a composite foil comprising a copper layer coated with a plated hard nickel layer as a dissimilar metal layer.

42. A printed wiring board with a built-in capacitor circuit which uses a capacitor layer forming material comprising a first electroconductive layer used for forming an upper electrode and second electroconductive layer used for forming a lower electrode with a dielectric layer in-between, wherein
the second electroconductive layer is made of a composite foil comprising a copper layer coated with a plated cobalt layer as a dissimilar metal layer.

43. A printed wiring board with a built-in capacitor circuit which uses a capacitor layer forming material comprising a first electroconductive layer used for forming an upper electrode and second electroconductive layer used for forming a lower electrode with a dielectric layer in-between, wherein
the second electroconductive layer is made of a composite foil comprising a copper layer coated with a plated nickel/cobalt alloy layer as a dissimilar metal layer.

44. Aprinted wiring board with a built-in capacitor circuit which uses a capacitor layer forming material comprising a first electroconductive layer used for forming an upper electrode and second electroconductive layer used for forming a lower electrode with a dielectric layer in-between, wherein
the second electroconductive layer is made of a composite foil comprising a copper layer coated with 2 dissimilar metal layers of plated cobalt and plated hard nickel in this order.

45. A printed wiring board with a built-in capacitor circuit which uses a capacitor layer forming material comprising a first electroconductive layer used for forming an upper electrode and second electroconductive layer used for forming a lower electrode with a dielectric layer in-between, wherein
the second electroconductive layer is made of a composite foil comprising a copper layer coated with 2 dissimilar metal layers of plated iron and plated hard nickel in this order.

46. A printed wiring board with a built-in capacitor circuit which uses a capacitor layer forming material comprising a first electroconductive layer used for forming an upper electrode and second electroconductive layer used for forming a lower electrode with a dielectric layer in-between, wherein
the second electroconductive layer is made of a composite foil comprising a copper layer coated with 3 dissimilar metal layers of plated cobalt, plated hard nickel and plated cobalt in this order.

47. A printed wiring board with a built-in capacitor circuit which uses a capacitor layer forming material comprising a first electroconductive layer used for forming an upper electrode and second electroconductive layer used for forming a lower electrode with a dielectric layer in-between, wherein
the second electroconductive layer is made of a composite foil comprising a copper layer coated with 3 dissimilar metal layers of plated iron, plated hard nickel and plated cobalt in this order.
